(19) United States
(12) Patent Application Publication
(10) Pub. No.: US 2026/0259577 A1
(43) Pub. Date: Sep. 3, 2026

(54) REACTION FORCE CONTROLLING APPARATUS AND REACTION FORCE CONTROLLING SYSTEM

(71) Applicant: Sony Group Corporation, Tokyo (JP)

(72) Inventor: Hiroto KAWAGUCHI, Tokyo (JP)

(21) Appl. No.: 18/873,488

(22) PCT Filed: May 19, 2023
(86) PCT No.: PCT/JP2023/018702

§ 371 Date: Dec. 10, 2024

(30) Foreign Application Priority Data
Jun. 16, 2022 (JP) 2022-097016

(51) Int. Cl. G05G 5/03; F15B 15/10

(52) U.S. Cl. CPC G05G 5/03; F15B 15/10; G05G 2505/00

(57) ABSTRACT

To provide a reaction force controlling apparatus and a reaction force controlling system that excellently control a reaction force.

[Solving Means] A reaction force controlling apparatus according to the present technology includes a first deformable body, a base, and a second deformable body. The first deformable body includes a first space inside of the first deformable body, the first space having a variable volume. The base includes a second space that communicates with the first space through a circulation hole, and a third space that does not communicate with the first space or the second space. The second deformable body separates the second space from the third space, the second deformable body being deformed to change the opening area of the circulation hole, the deformation being performed due to fluid flowing into the third space or flowing out of the third space.

### TECHNICAL FIELD

The present technology relates to a reaction force controlling apparatus and a reaction force controlling system that control a reaction force.

### BACKGROUND ART

When a user touches or operates an object, the user feels a reaction force dependent on physical properties or a shape of the object. An appropriate control of the reaction force makes it possible to provide various kinds of tactile sense artificially. A method for providing a reaction force using an electromagnetic force, that is, a motor is one of the most commonly used methods for providing such a reaction force. However, the use of a motor results not only in difficulty in providing a reaction force immediately after input is performed, but also in there being limitations on the type of reaction force that can be provided. For example, it is difficult to provide a reaction force representing a sticky feel.

On the other hand, an approach of providing a reaction force by use of principles other than the principles of an electromagnetic force has also been developed. This is an approach using air pressure, and is an approach of providing any force to a user by intaking air into a sealed space in a flexible body or discharging air from the sealed space in the flexible body to develop deformation of the flexible body due to a change in air pressure.

For example, Patent Literature 1 discloses including a circulation hole that communicates with a space in a flexible film body, where the circulation hole causes flow resistance to act on air passing through the circulation hole, and this provides specified spring characteristics of and a specified vibration range damping performance of the flexible film body. Further, Patent Literature 2 discloses changing, using an electromagnetic actuator, an amount of opening of an orifice valve arranged in a flow path, and Patent Literature 3 discloses using an iris-type diaphragm as a mechanism that changes the area of a cross section of a fluid circulation hole.

### CITATION LIST

### Patent Literature

Patent Literature 1: Japanese Patent Application Laid-open No. 2008-115959

Patent Literature 2: Japanese Unexamined Utility Model Application Publication No. 5 -002215

Patent Literature 3: Japanese Unexamined Patent Application Publication No. 2008-522319

### DISCLOSURE OF INVENTION

### Technical Problem

There are a spring constant component and a dumping component that are force-reaction factors necessary to serve as a tactile sense. The spring constant component refers to a coefficient of a reaction force for a pressing amount, and the dumping component refers to a coefficient of a reaction force for a pressing speed. The provision of a reaction force controlling apparatus that excellently controls the spring constant component and the dumping component makes it possible to provide various kinds of tactile sense. However, in the case of the configuration disclosed in Patent Literature 1, the spring constant component and the dumping component are determined by a diameter of the circulation hole, and thus are not allowed to be adjusted discretionarily.

Further, in the case of the configuration disclosed in Patent Literature 2, it is difficult to control an electromagnetic open-and-close valve between an open state and a closed state, and to control a slight change in dumping component. It is difficult to control a speed of an operation of the electromagnetic open-and-close valve. Especially, the operation at a slow speed is difficult, and vibration or noise due to collision is easily caused upon operating at a high speed. Further, in the case of the configuration disclosed in Patent Literature 3, there occur problems with an operational speed, an operational sound, and the reliability of the mechanical mechanism section. Thus, there has been difficulty in providing a reaction force controlling apparatus that excellently controls the spring constant component and the dumping component.

In view of the circumstances described above, it is an object of the present technology to provide a reaction force controlling apparatus and a reaction force controlling system that excellently control a reaction force.

### Solution to Problem

In order to achieve the object described above, a reaction force controlling apparatus according to an embodiment of the present technology includes a first deformable body, a base, and a second deformable body.

The first deformable body includes a first space inside of the first deformable body, the first space having a variable volume.

The base includes a second space that communicates with the first space through a circulation hole, and a third space that does not communicate with the first space or the second space.

The second deformable body separates the second space from the third space, the second deformable body being deformed to change the opening area of the circulation hole, the deformation being performed due to fluid flowing into the third space or flowing out of the third space.

The second deformable body may expand due to the flow of the fluid into the third space to close a portion of or all of the circulation hole, and may shrink due to the flow of the fluid out of the third space to be spaced from the circulation hole.

The reaction force controlling mechanism may cause the fluid to flow into the third space, and may cause the fluid to flow out of the third space.

The second space may communicate with an external space through a first flow path, and the third space may be connected to the first fluid control mechanism through a second flow path.

The reaction force controlling apparatus may further include a second fluid control mechanism that causes the fluid to flow into the first space, and that causes the fluid to flow out of the first space, and the first space may be connected to the second fluid control mechanism through a third flow path.

A plurality of the circulation holes may be provided, and the number of the circulation holes closed with the second deformable body may be changed according to an amount of the deformation of the second deformable body.

The circulation hole may be shaped such that the area of a portion of the circulation hole that is closed with the second deformable body is changed according to an amount of the deformation of the second deformable body. the first deformable body may have a bellows structure.

The first deformable body may have a piston structure.

The first deformable body may have a balloon structure.

The second deformable body may be a stretchable deformable film.

In order to achieve the object described above, a reaction force controlling system according to an embodiment of the present technology includes a reaction force controlling apparatus and a controller.

The reaction force controlling apparatus includes
a first deformable body that includes a first space inside of the first deformable body, the first space having a variable volume,
a base that includes
   a second space that communicates with the first space through a circulation hole, and
   a third space that does not communicate with the first space or the second space,
   a second deformable body that separates the second space from the third space, the second deformable body being deformed to change the opening area of the circulation hole, the deformation being performed due to fluid flowing into the third space or flowing out of the third space, and
   a first fluid control mechanism that causes the fluid to flow into the third space, and that causes the fluid to flow out of the third space.

The controller controls the first fluid control mechanism to adjust an internal pressure in the third space.

The controller may keep a relationship between an amount of the deformation of the second deformable body and the internal pressure in the third space, and may adjust the internal pressure in the third space such that the amount of the deformation of the second deformable body is a specified amount.

The reaction force controlling system may further include a load sensor that detects a load applied to the first deformable body, and the controller may adjust the internal pressure in the third space on the basis of output from the load sensor.

The controller may change the internal pressure in the third space as necessary according to the load.

The reaction force controlling system may further include a range sensor that detects an amount of deformation of the first deformable body, and the controller may adjust the internal pressure in the third space on the basis of output from the range sensor.

The controller may change the internal pressure in the third space as necessary according to the amount of the deformation.

The controller may adjust the internal pressure in the third space on the basis of input performed by a user.

The controller may adjust the internal pressure in the third space on the basis of designation performed by an application.

The reaction force controlling apparatus may further include a second fluid control mechanism that causes the fluid to flow into the first space, and that causes the fluid to flow out of the first space, the first space may be connected to the second fluid control mechanism through a third flow path, and the controller may further control the second fluid control mechanism to adjust an internal pressure in the first space.

### BRIEF DESCRIPTION OF DRAWINGS

FIG. 1 schematically illustrates a reaction force controlling apparatus according to embodiments of the present technology.

FIG. 2 schematically illustrates deformation of a first deformable body that is included in the reaction force controlling apparatus.

FIG. 3 schematically illustrates a base that is included in the reaction force controlling apparatus.

FIG. 4 schematically illustrates deformation of a second deformable body that is included in the reaction force controlling apparatus.

FIG. 5 is a graph in which spring effects of the reaction force controlling apparatus are given.

FIG. 6 is a graph in which damper effects of the reaction force controlling apparatus are given.

FIG. 7 schematically illustrates an operation of the reaction force controlling apparatus.

FIG. 8 schematically illustrates the operation of the reaction force controlling apparatus.

FIG. 9 is an exploded perspective view illustrating a specific configuration of the reaction force controlling apparatus.

FIG. 10 is an exploded cross-sectional view illustrating the specific configuration of the reaction force controlling apparatus.

FIG. 11 is a cross-sectional view of a specific configuration of the first deformable body included in the reaction force controlling apparatus.

FIG. 12 is a perspective view of the first deformable body included in the reaction force controlling apparatus.

FIG. 13 schematically illustrates a modification of the first deformable body included in the reaction force controlling apparatus.

FIG. 14 is a cross-sectional view illustrating a specific configuration of a base that is included in the reaction force controlling apparatus.

FIG. 15 is a plan view of a circulation hole plate that is included in the reaction force controlling apparatus.

FIG. 16 schematically illustrates joint of the first deformable body and circulation hole plate included in the reaction force controlling apparatus.

FIG. 17 is an exploded cross-sectional view of the base included in the reaction force controlling apparatus.

FIG. 18 schematically illustrates deformation of a deformable film that is the second deformable body included in the reaction force controlling apparatus.

FIG. 19 schematically illustrates a relationship between deformation of the deformable film included in the reaction force controlling apparatus, and the circulation hole.

FIG. 20 schematically illustrates the relationship between the deformation of the deformable film included in the reaction force controlling apparatus, and the circulation hole.

FIG. 21 schematically illustrates the relationship between the deformation of the deformable film included in the reaction force controlling apparatus, and the circulation hole.

FIG. 22 schematically illustrates an example of the circulation hole being included in the reaction force controlling apparatus and having another shape.

FIG. 23 schematically illustrates an example of the circulation hole being included in the reaction force controlling apparatus and having another shape.

FIG. 24 schematically illustrates an example of the circulation hole being included in the reaction force controlling apparatus and having another shape.

FIG. 25 is a cross-sectional view illustrating another configuration of the first deformable body included in the reaction force controlling apparatus.

FIG. 26 is a cross-sectional view illustrating another configuration of the second deformable body included in the reaction force controlling apparatus.

FIG. 27 is a cross-sectional view illustrating another configuration of the second deformable body included in the reaction force controlling apparatus.

FIG. 28 is a cross-sectional view illustrating another configuration of the second deformable body included in the reaction force controlling apparatus.

FIG. 29 is a cross-sectional view illustrating another configuration of the second deformable body included in the reaction force controlling apparatus.

FIG. 30 schematically illustrates a size of a bellows that is included in the first deformable body included in the reaction force controlling apparatus.

FIG. 31 schematically illustrates a size of the circulation hole plate included in the base included in the reaction force controlling apparatus.

FIG. 32 schematically illustrates sizes of respective members included in the base included in the reaction force controlling apparatus.

FIG. 33 illustrates a result of measuring an amount of pressing the bellows and a static reaction force of the bellows in the reaction force controlling apparatus according to examples of the present technology.

FIG. 34 illustrates a result of measuring the amount of pressing the bellows and a reaction force of the bellows in the reaction force controlling apparatus according to the examples of the present technology (2 kPa, 1 mm/s).

FIG. 35 illustrates a result of measuring the amount of pressing the bellows and the reaction force of the bellows in the reaction force controlling apparatus according to the examples of the present technology (2 kPa, 10 mm/s).

FIG. 36 illustrates a result of measuring the amount of pressing the bellows and the reaction force of the bellows in the reaction force controlling apparatus according to the examples of the present technology (2 kPa, 50 mm/s).

FIG. 37 illustrates a result of measuring the amount of pressing the bellows and the reaction force of the bellows in the reaction force controlling apparatus according to the examples of the present technology (10 kPa, 1 mm/s).

FIG. 38 illustrates a result of measuring the amount of pressing the bellows and the reaction force of the bellows in the reaction force controlling apparatus according to the examples of the present technology (10 kPa, 10 mm/s).

FIG. 39 illustrates a result of measuring the amount of pressing the bellows and the reaction force of the bellows in the reaction force controlling apparatus according to the examples of the present technology (10 kPa, 50 mm/s).

FIG. 40 schematically illustrates a reaction force controlling system according to the embodiments of the present technology.

FIG. 41 is a graph in which an example of controlling a reaction force caused on the first deformable body is given, the control being performed by a controller that is included in the reaction force controlling system.

FIG. 42 is a graph in which an example of controlling a reaction force caused on the first deformable body is given, the control being performed by the controller included in the reaction force controlling system.

FIG. 43 is a graph in which an example of controlling a reaction force caused on the first deformable body is given, the control being performed by the controller included in the reaction force controlling system.

FIG. 44 is a graph in which an example of controlling a reaction force caused on the first deformable body is given, the control being performed by the controller included in the reaction force controlling system.

FIG. 45 is a flowchart illustrating an operation of the controller by use of output from a sensor, the controller being included in the reaction force controlling system.

FIG. 46 is a graph in which an example of controlling a reaction force caused on the first deformable body is given, the control being performed by the controller included in the reaction force controlling system, on the basis of output from a sensor.

FIG. 47 is a graph in which an example of controlling a reaction force caused on the first deformable body is given, the control being performed by the controller included in the reaction force controlling system, on the basis of the output from the sensor.

FIG. 48 is a graph in which an example of controlling a reaction force caused on the first deformable body is given, the control being performed by the controller included in the reaction force controlling system, on the basis of the output from the sensor.

FIG. 49 is a graph in which an example of controlling a reaction force caused on the first deformable body is given, the control being performed by the controller included in the reaction force controlling system, on the basis of the output from the sensor.

FIG. 50 schematically illustrates a state in which the bellows included in the first deformable body included in the reaction force controlling apparatus is deformed.

FIG. 51 schematically illustrates a state in which the bellows included in the first deformable body included in the reaction force controlling apparatus is deformed.

FIG. 52 schematically illustrates an oscillating mechanism using the reaction force controlling apparatus.

FIG. 53 schematically illustrates a joint mechanism using the reaction force controlling apparatus.

FIG. 54 schematically illustrates the reaction force controlling apparatus according to a modification of the present technology.

FIG. 55 schematically illustrates the reaction force controlling apparatus according to a modification of the present technology.

FIG. 56 schematically illustrates the reaction force controlling apparatus according to a modification of the present technology.

FIG. 57 schematically illustrates the reaction force controlling apparatus according to a modification of the present technology.

FIG. 58 schematically illustrates the reaction force controlling apparatus according to a modification of the present technology.

FIG. 59 is a block diagram illustrating a hardware configuration of the controller included in the reaction force controlling system according to the embodiments of the present technology.

### MODE(S) FOR CARRYING OUT THE INVENTION

A reaction force controlling apparatus according to embodiments of the present technology is described.

### Configuration of Reaction Force Controlling Apparatus

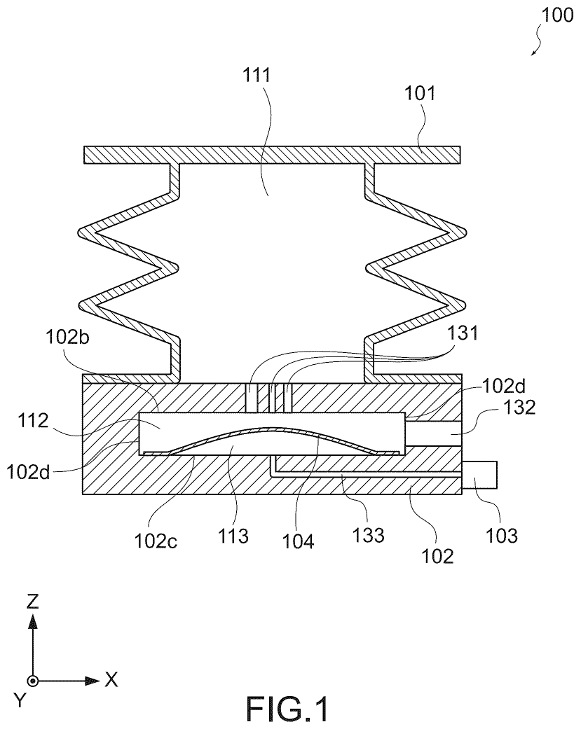

FIG. 1 schematically illustrates a reaction force controlling apparatus 100 according to the present embodiment. As illustrated in the figure, the reaction force controlling apparatus 100 includes a first deformable body 101, a base 102, a first fluid control mechanism 103, and a second deformable body 104.

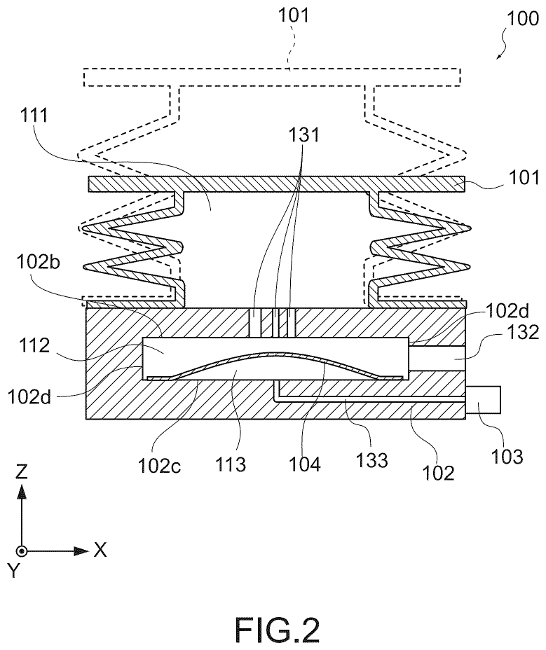

The first deformable body 101 can be deformed, and a space is provided inside of the first deformable body 101. The first deformable body 101 may have a bellows structure, as described later. The internal space of the first deformable body 101 is hereinafter referred to as a first space 111. FIG. 2 schematically illustrates deformation of the first deformable body 101. The volume of the first space 111 is variable. The volume of the first space 111 varies as the first deformable body 101 is deformed, as illustrated in FIG. 2.

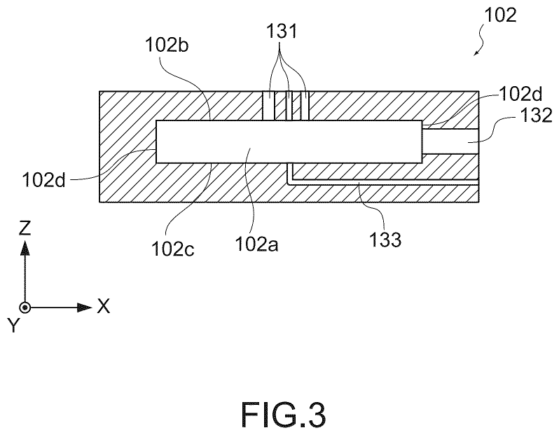

The base 102 is joined to the first deformable body 101, and a space is provided inside of the base 102. FIG. 3 is a cross-sectional view of the base 102. As illustrated in the figure, the base 102 includes an internal space 102a, and the internal space 102a is surrounded by a top surface 102b, a bottom surface 102c, and a side surface 102d. The top surface 102b and the bottom surface 102c are surfaces that face each other, and the side surface 102d is a surface that connects the top surface 102b and the bottom surface 102c. The internal space 102a is partitioned by the second deformable body 104 into two spaces, as illustrated in FIG. 1. The two spaces are hereinafter referred to as a second space 112 and a third space 113. The second space 112 is a space situated on the side of the first space 111, and is a space situated between the second deformable body 104 and the top surface 102b. The third space 112 is a space situated opposite to the first space 111, and is a space situated between the second deformable body 104 and the bottom surface 102c.

As illustrated in FIG. 1, the base 102 includes a circulation hole 131, a first flow path 132, and a second flow path 133. The circulation hole 131 is provided between the first space 111 and the second space 112, and the circulation hole 131 causes the first space 111 and the second space 112 to communicate with each other. As illustrated in FIG. 3, the circulation hole 131 may be provided to the top surface 102b. A single circulation hole 131 or a plurality of circulation holes 131 may be provided.

The first flow path 132 is provided between the second space 112 and an external space, and the first flow path 132 causes the second space 112 and the external space to communicate with each other. As illustrated in FIG. 3, the first flow path 132 may be provided to the side surface 102d. The flow-path area of the first flow path 132 is officially larger than a total of the opening areas of the circulation holes 131. The second flow path 133 connects the third space 113 and the first fluid control mechanism 103. As illustrated in FIG. 3, the second flow path 133 may be provided to the bottom surface 102c. As described above, the first space 111 and the second space 112 communicate with each other through the circulation hole 131. On the other hand, the third space 113 does not communicate with the first space 111 or the second space 112.

The first fluid control mechanism 103 causes fluid to flow into the third space 113 through the second flow path 133, and causes fluid to flow out of the third space 113 through the second flow path 133. The fluid may be air, or may be gas other than air or liquid. The first fluid control mechanism 103 is, for example, a pump.

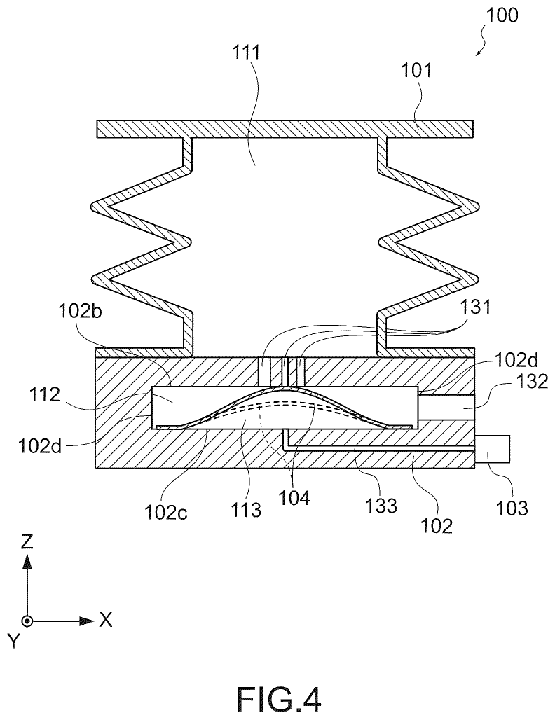

The second deformable body 104 is arranged between the second space 112 and the third space 113 to separate the second space 112 from the third space 113. The second deformable body 104 is stretchable, and a peripheral edge of the second deformable body 104 is joined to the bottom surface 102c. The second deformable body 104 expands due to fluid flowing into the third space 113, and shrinks due to fluid flowing out of the third space 113. FIG. 4 schematically illustrates expansion of the second deformable body 104.

When the first fluid control mechanism 103 causes fluid to flow into the third space 112, an internal pressure in the third space 112 is increased, and the second deformable body 104 expands, as illustrated in FIG. 4. The second deformable body 104 is brought into contact with the top surface 102b to close a portion of or all of the circulation hole 131. Further, when the first fluid control mechanism 103 causes fluid to flow out of the third space 112, the internal pressure in the third space 112 is decreased, and the second deformable body 104 shrinks, as illustrated in FIG. 1. The second deformable body 104 is moved to be spaced from the top surface 102b and the circulation hole 131 to open the circulation hole 131. In other words, the second deformable body 104 is deformed to change the opening area of the circulation hole 131, the deformation being performed due to fluid flowing into the third space 113 or flowing out of the third space 113. Note that, as described later, the number of circulation holes 131 closed with the second deformable body 104 may be changed according to an amount of deformation of the second deformable body 104, or the circulation hole 131 may be shaped such that the area of a portion of the circulation hole 131 that is closed with the second deformable body 104 is changed according to the amount of the deformation of the second deformable body 104.

### Operation of Reaction Force Controlling Apparatus

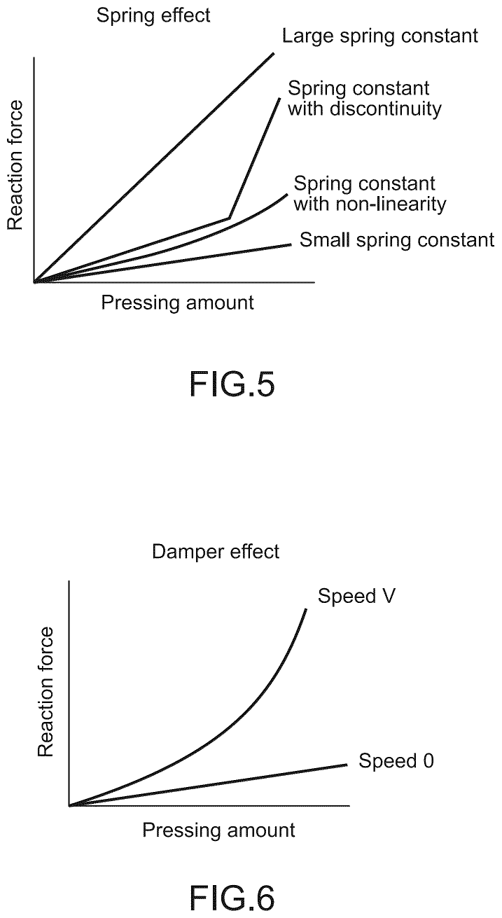

The reaction force controlling apparatus 100 can control a spring constant component and a dumping component of a reaction force caused due to pushing being performed with, for example, a finger. FIG. 5 is a graph in which spring effects are given. As illustrated in the figure, the spring constant component refers to a coefficient of a reaction force for a pressing amount, and there are typically a large number of examples in which the reaction force is linearly proportional to the pressing amount. However, a real object has a spring constant exhibiting the non-linearity or discontinuity. FIG. 6 is a graph in which damper effects are given. As illustrated in the figure, the dumping component refers to a coefficient of a reaction force for a pressing speed, and the reaction force typically tends to be increased as the pressing speed is increased. In the reaction force controlling apparatus 100, the control of a spring constant component and a dumping component makes it possible to perform pseudo-provision of feelings of reaction forces of various objects, as described below.

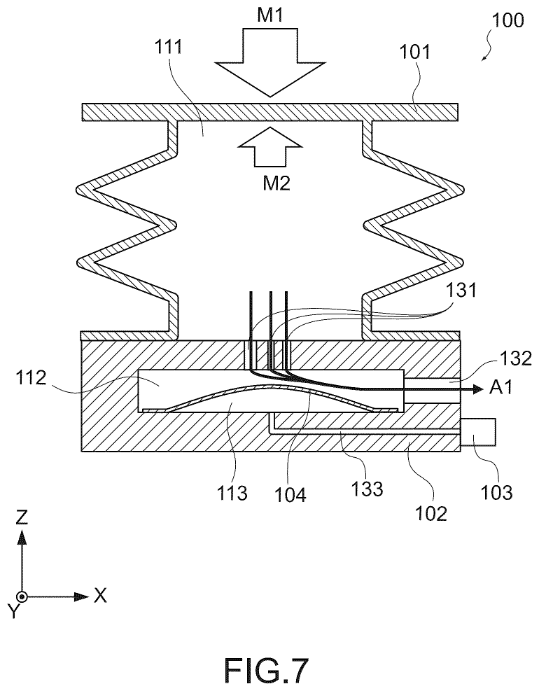

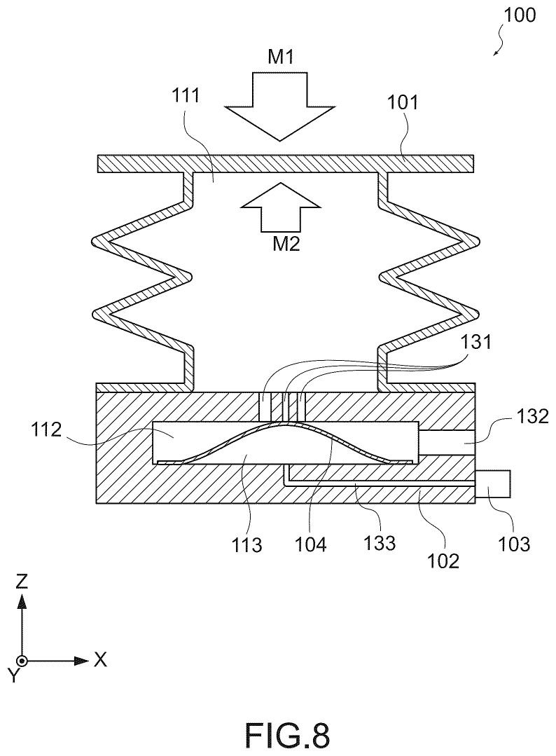

FIGS. 7 and 8 schematically illustrate an operation of the reaction force controlling apparatus 100. In FIGS. 7 and 8, a force applied to the first deformable body 101 is referred to as a force M1, and a reaction force caused on the first deformable body 101 is referred to as a reaction force M2. The force M1 is a force applied to the first deformable body 101 with, for example, a finger of a user, and the reaction force M2 is a force with which, for example, the finger is pressed back from the first deformable body 101.

FIG. 7 illustrates a state in which the internal pressure in the third space 112 is low. When the internal pressure in the third space 112 is low, the second deformable body 104 shrinks, and does not close the circulation hole 131, as described above. When the force M1 is applied to the first deformable body 101 in this state, air in the first space 111 passes through the circulation hole 131 to flow into the second space 112, and flows out of the second space 112 through the first flow path 132 to flow into an external space, as indicated by an arrow A1. Here, a flow path resistance to air passing through the circulation hole 131 is low. Thus, the reaction force M2 caused on the first deformable body 101 is caused due to a spring constant component and a dumping component of the first deformable body 101.

On the other hand, FIG. 8 illustrates a state in which the internal pressure in the third space 112 is high. When the internal pressure in the third space 112 is high, the second deformable body 104 expands, and closes a portion of the circulation hole 131, as described above. When the force M1 is applied to the first deformable body 101 in this state, air in the first space 111 passes through the circulation hole 131 to flow into the second space 112, and the flow path resistance is increased since the circulation hole 131 is partially closed with the second deformable body 104. This results in changing the reaction force M2 (a damper effect) according to a pressing speed. The reaction force M2 is increased when the pressing speed is high, and the reaction force M2 is decreased when the pressing speed is low.

When the internal pressure in the third space 112 is further increased in this state, the second deformable body 104 further expands, and completely closes the circulation holes 131. When the force M1 is applied to the first deformable body 101 in this state, the first deformable body 101 becomes a sealed air spring body since air in the first space 111 is not allowed to pass through the circulation hole 131. This results in a significant increase in spring constant. Here, a high pressure is also applied to the second deformable body 104 through the circulation holes 131. However, when the second deformable body 104 has an area sufficiently greater than a total of the opening areas of the circulation holes 131, this enables the circulation holes 131 to remain sealed without greatly increasing supply pressure applied to the third space 113.

In the reaction force controlling apparatus 100, the control of the internal pressure in the third space 113 using the first fluid control mechanism 103 makes it possible to increase or reduce the opening area of the circulation hole 131, and to change a spring constant component and a dumping component of the first deformable body 101, as described above. Note that, in this configuration, the second deformable body 104 has an area significantly larger than the opening area of the circulation hole 131. This makes it possible to increase the reaction force M2 without increasing the internal pressure in the third space 113.

Further, when the force M1 is excessively applied to the first deformable body 101 in a state in which a portion of or all of the circulation hole 131 is closed with the second deformable body 104, an internal pressure in the first space 111 is increased to press back the second deformable body 104 with which the circulation hole 131 is closed, and gas passes through the circulation hole 131. Thus, the second deformable body 104 acts as a relief valve, and this makes it possible to prevent the reaction force controlling apparatus 100 from being damaged or subjected to impact due to the force M1 being excessively applied to the reaction force controlling apparatus 100. This contributes toward securing safety when the reaction force controlling apparatus 100 is worn on a human body.

### Effects Provided by Reaction Force Controlling Apparatus

As described above, the reaction force controlling apparatus 100 makes it possible to change a spring constant component and a dumping component that are obtained due to the first deformable body 101 being pushed. This change can be performed by adjusting the internal pressure in the third space 113 using the first fluid control mechanism 103. The internal pressure in the third space 113 can be adjusted with a low supply pressure. This makes it possible to change the spring constant component and the dumping component with excellent responsiveness. Further, the operation of the first fluid control mechanism 103 makes it possible to cause the spring constant component to exhibit various characteristics illustrated in FIG. 5 and to cause the dumping component to exhibit various characteristics illustrated in FIG. 6. This results in controlling the spring constant component and the dumping component excellently.

Further, the reaction force controlling apparatus 100 makes it possible to control a spring constant component and a dumping component by fluid being supplied by the first fluid control mechanism 103. This results in there being no need for, for example, a motor. Thus, the spring constant component and the dumping component can be controlled without causing mechanically operating noise. Further, the reaction force controlling apparatus 100 is flexible in design, and this makes it possible to easily provide reaction-force characteristics according to the purpose by use of, for example, characteristics of the first deformable body 101, and the opening area and arrangement of the circulation hole 131.

### Field to Which Reaction Force Controlling Apparatus is Applied

When the reaction force controlling apparatus 100 is incorporated into a tactile sense generating apparatus, this makes it possible to represent an object that provides a stiff or soft feeling of an object, that is, an object, such as a rubber material or a foam material, that exhibits a non-linear spring effect or a damper effect. The reaction force controlling apparatus 100 can be applied to, for example, the use for checking softness of a cushion remotely to determine whether to purchase the cushion, the use for diagnosis by examination by touch on, for example, a lump or swelling, the use for learning suitable times for the level of mixture or the level of hardening upon manufacturing various objects, and the use for improving the performance with respect to feelings of reaction forces.

Further, when the reaction force controlling apparatus 100 is incorporated into an input apparatus to which a tactile sense is assigned, this makes it possible to change a switching feeling of a reaction force. The reaction force controlling apparatus 100 can be applied to, for example, the use for enabling a user to select a desired operational feel by changing a profile of the reaction force according to the application upon performing operation using a pressing amount; and the use for arranging, for example, a reward (the ease of use) in the form of a tactile sense such as changing a pressing feel according to the type of an outfit used during a game, or letting a user know the type of a selected tool by the switching feeling or making a reaction force light every time a game is beat.

Further, the application to, for example, a robot hand makes it possible to use a change in elastic characteristics such as a change from a light spring to damper, and from damper to a spring exhibiting a high spring constant. The reaction force controlling apparatus 100 is incorporated into a joint or an actuator, and can be used as a mechanism that eases an operation of a primary actuator or secures safety. Furthermore, the application to an anti-vibration base makes it possible to enhance a vibration isolation frequency by controlling the opening area of the circulation hole 131. Here, mechanical oscillation or noise upon operation is reduced since the second deformable body 104 is flexible. Further, the change in the opening area of the circulation hole 131 makes it possible to change anti-vibration characteristics.

Moreover, the reaction force controlling apparatus 100 can be used in the form of, for example, an installation-type apparatus such as a linkage-type force apparatus, a control board, and an apparatus for driving; a holdable apparatus such as a controller including a mouse, a game controller, and various remote controller apparatuses; a wearable apparatus such as a hand wearable apparatus and an arm wearable apparatus; various robots; or support legs of a vibration isolation base.

### Specific Configuration of Reaction Force Controlling Apparatus

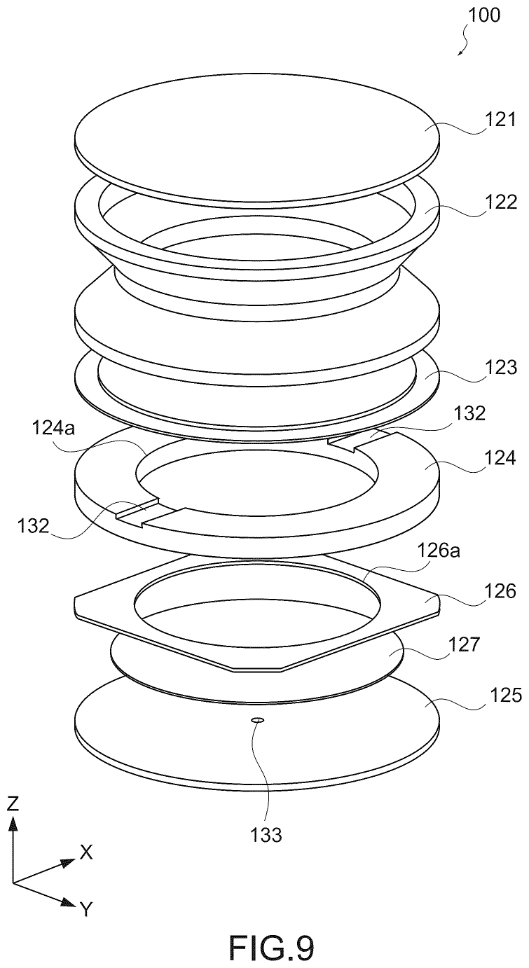

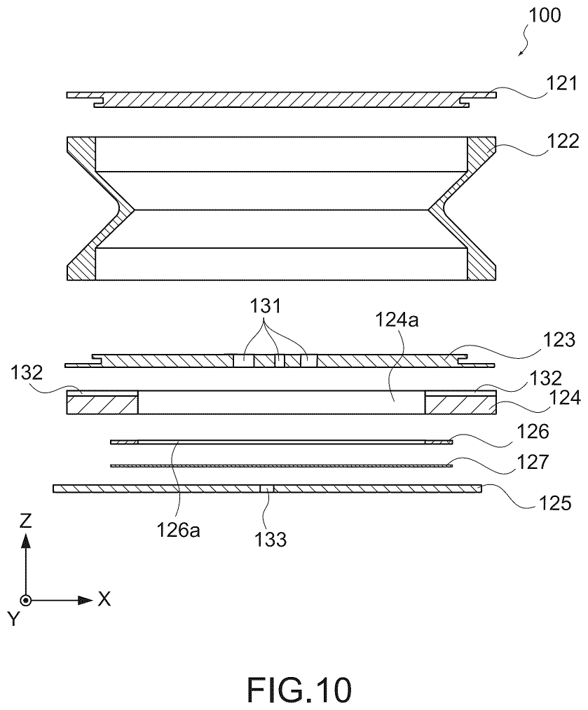

A more specific configuration of the reaction force controlling apparatus 100 is described. FIG. 9 is an exploded perspective view of the reaction force controlling apparatus 100, and FIG. 10 is an exploded cross-sectional view of the reaction force controlling apparatus 100. As illustrated in FIGS. 9 and 10, the reaction force controlling apparatus 100 includes an upper plate 121, a bellows 122, a circulation hole plate 123, a spacer 124, an air circulation plate 125, a holding plate 126, and a deformable film 127. Note that an illustration of the first fluid control mechanism 103 is omitted in FIG. 9.

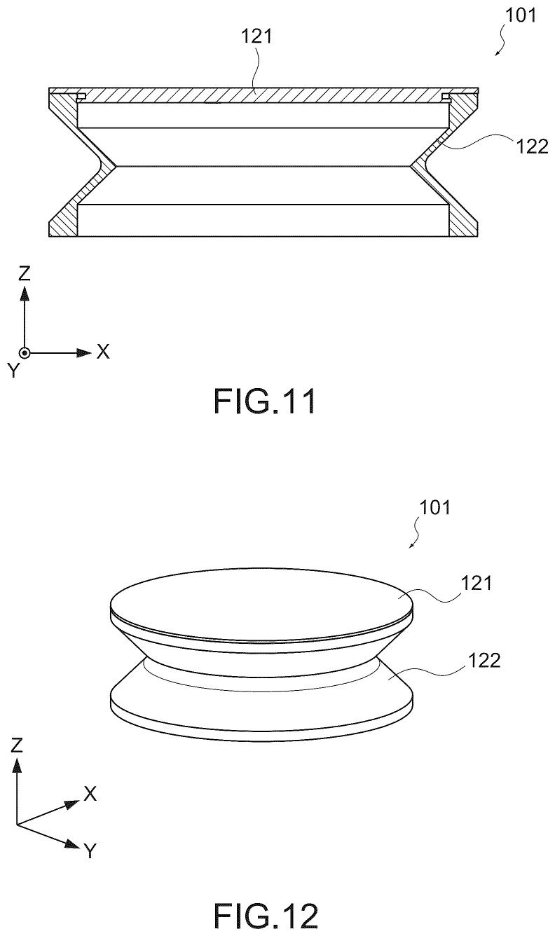

The upper plate 121 and the bellows 122 form the first deformable body 101 described above. FIG. 11 is a cross-sectional view of the first deformable body 101 formed by the upper plate 121 and the bellows 122. As illustrated in the figure, the upper plate 121 is joined to an end of the bellows 122.

Favorably, a material that is more rigid than the bellows 122 is used as a material of the upper plate 121, and, for example, the upper plate 121 is made of metal such as stainless, aluminum, or brass; or a plastic material such as polycarbonate (PC) or acrylonitrile butadiene styrene (ABS). The upper plate 121 is closely joined to the bellows 122 to keep the first space 111 hermetically sealed.

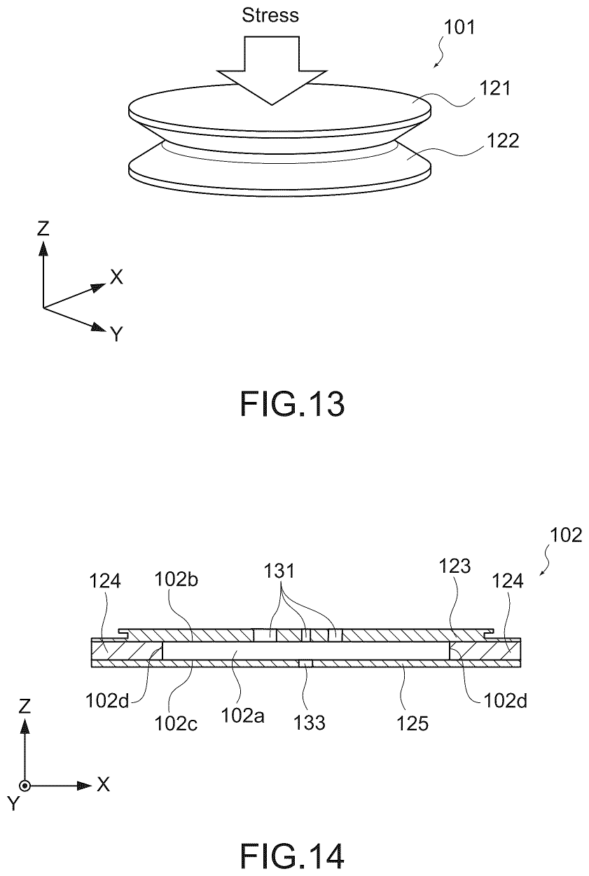

A bending portion having a desired angle is formed in an outer peripheral portion of the bellows 122, and the bellows 122 is stretchable. FIGS. 12 and 13 are perspective views of the first deformable body 101. As illustrated in FIG. 12, the bellows 122 has a certain height. However, the bellows 122 is compressed when stress is applied to the bellows 122, as illustrated in FIG. 13, and a shape of the bellows 122 returns to its original state, as illustrated in FIG. 12, when stress is not applied to the bellows 122. The number of bending portions and an angle of the bending portion are not particularly limited. When a large spring constant is desired to be obtained, a midway portion of the bellows 122 is narrowed such that the area of a portion of the bellows 122 on the side of the upper plate 121 is made larger, as illustrated in FIG. 11. The reason is that a force F caused by the bellows 122 satisfies F=P·S when P represents the internal pressure in the first space 111 and S represents the area of the bellows. The bellows 122 may be made of an elastic material such as silicon rubber or nitrile rubber.

The circulation hole plate 123, the spacer 124, and the air circulation plate 125 form the base 102. FIG. 14 is a cross-sectional view of the base 102 formed by the circulation hole plate 123, the spacer 124, and the air circulation plate 125. As illustrated in the figure, the circulation hole plate 123 is joined to one of surfaces of the annular spacer 124, and the air circulation plate 125 is joined to another of the surfaces of the annular spacer 124 to form the base 102. Accordingly, the internal space 102a is formed. A surface of the circulation hole plate 123 that is situated on the side of the spacer 124 forms the top surface 102b, and a surface of the air circulation plate 125 that is situated on the side of the spacer 124 forms the bottom surface 102c. An inner peripheral surface of the spacer 124 forms the side surface 102d.

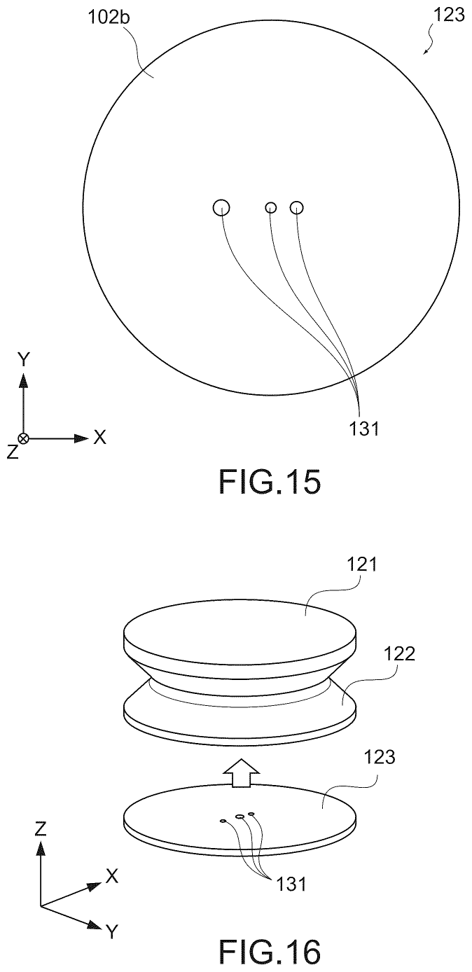

The circulation hole plate 123 is a plate that is provided with the circulation hole 131. FIG. 15 is a plan view of the circulation hole plate 123, as viewed from the second space 112. In the figure, three circulation holes 131 are provided to a center portion of the circulation hole plate 123. The number of circulation holes 131 is not limited to three, and may be two or less, or four or more. The respective circulation holes 131 may have equal opening areas or different opening areas. The circulation hole 131 may have any shape such as a circle, a square, a rectangle, or a polygon.

FIG. 16 schematically illustrates joint of the circulation hole plate 123 and the bellows 122. As illustrated in the figure, the circulation hole plate 123 is joined to the bellows 122 to seal the first space 111. A method for joining the circulation hole plate 123 and the bellows 122 is not particularly limited. Accordingly, the circulation hole plate 123 separates the first space 111 from the second space 112, and only the circulation hole 131 causes the first space 111 and the second space 112 to communicate with each other.

The spacer 124 causes the circulation hole plate 123 and the air circulation plate 125 to be spaced from each other with specified spacing. As illustrated in FIG. 9, the spacer 124 is an annular member and is provided with an opening 124a in a center portion of the spacer 124, where a notch that serves as the first flow path 132 is provided to the spacer 124. The number of first flow paths 132 may be one, or two or more.

The air circulation plate 125 is a plate that is provided with the second flow path 133, as illustrated in FIG. 9. The second flow path 133 may be a flow path that passes through the air circulation plate 125, or may be a flow path that extends up to an end surface of the air circulation plate 125.

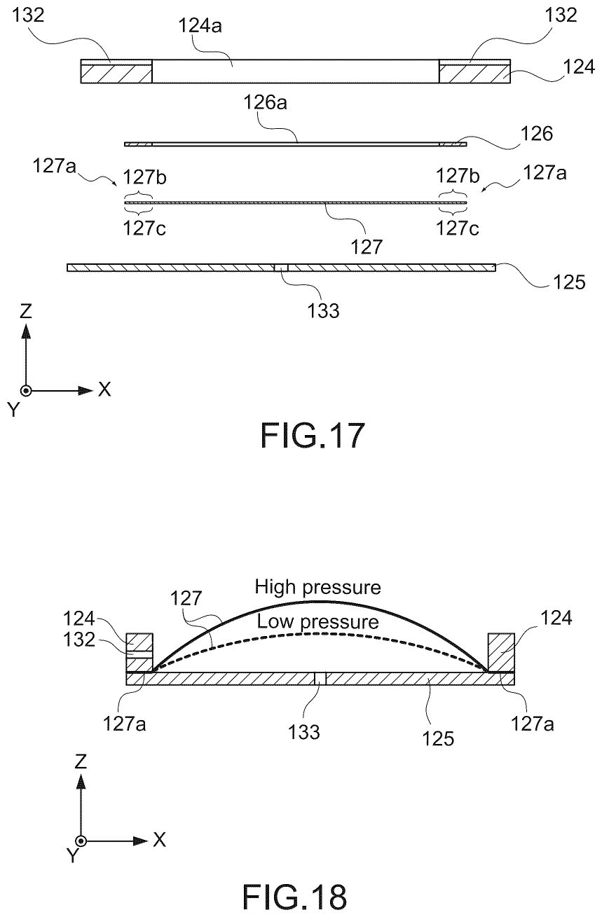

As illustrated in FIG. 9, the holding plate 126 is a frame-shaped member and is provided with an opening 126a in a center portion of the holding plate 126, where the holding plate 126 fixes the deformable film 127 to the base 102. FIG. 17 schematically illustrates fixation of the deformable film 127 using the holding plate 126. An outer peripheral portion of the deformable film 127 is referred to as a fixation portion 127a, as illustrated in the figure. A region of the fixation portion 127a that is situated on the side of the holding plate 126 is referred to as a region 127b, and a region of the fixation portion 127a that is situated opposite to the holding plate 126 is referred to as a region 127c. The holding plate 126 is brought into contact with the region 127b, and the region 127c is bonded to the air circulation plate 125 using an adhesive material. When the air circulation plate 125 and the spacer 124 are joined to each other, the holding plate 126 is sandwiched between the air circulation plate 125 and the spacer 124 to be fixed to the base 102.

The deformable film 127 is a stretchable film, and is the second deformable body 104 described above. The deformable film 127 separates the second space 112 from the third space 113. FIG. 18 schematically illustrates deformation of the deformable film 127. As illustrated in FIG. 17, the fixation portion 127a of the deformable film 127 is fixed using the holding plate 126. When fluid is supplied through the second flow path 133 in FIG. 18, the deformable film 127 expands according to the internal pressure in the third space 113, as illustrated in FIG. 18.

A material of the deformable film 127 has a relatively low modulus of elasticity, and a stretchable material is suitable for the deformable film 127. For example, a flexible material such as nitrile rubber or silicon rubber, or a highly stretchable elastomer material may be used for the deformable film 127. Particularly when supply pressure that is applied using the first fluid control mechanism 103 is low, a material that causes a great deformation with a minimum pressure is suitable for the deformable film 127. The deformation sensitivity to pressure is determined by a fixation structure of the deformable film 127, and a modulus of elasticity of a material used to form the deformable film 127 or a thickness of the film. In the reaction force controlling apparatus 100, it is necessary to change, due to an amount of deformation of the deformable film 127, the area of a portion of the deformable film 127 that is brought into contact with the circulation hole. Deformation characteristics of the deformable film 127 have a close relationship with a formation position at which the circulation hole 131 is formed.

### Regarding Circulation Hole

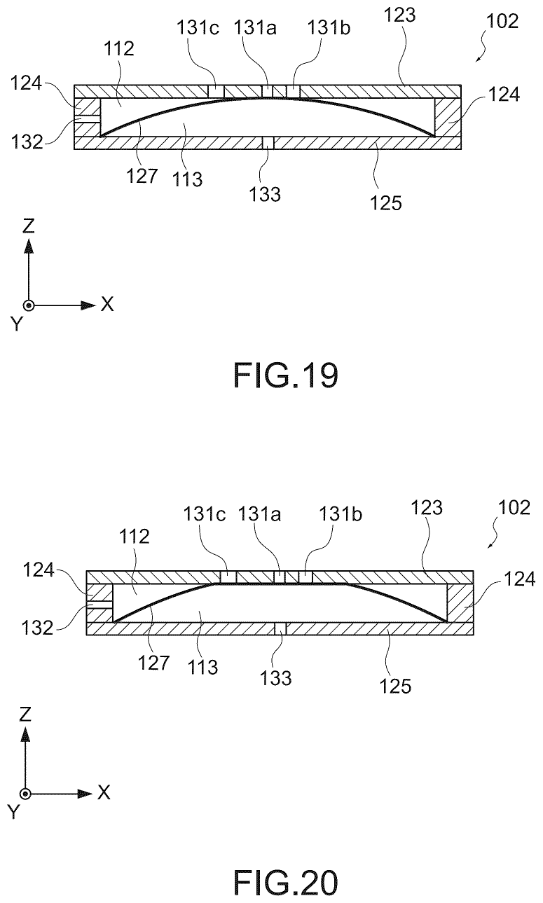

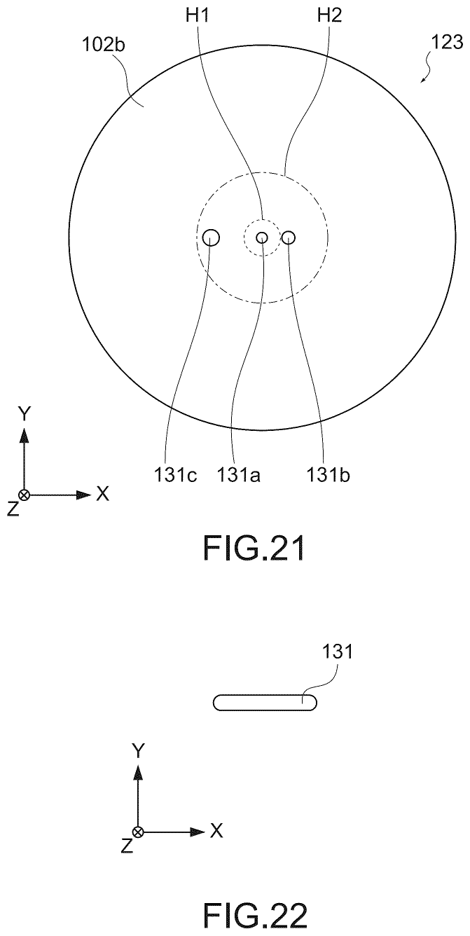

A position of the circulation hole 131 is determined in consideration of a shape of the deformable film 127 upon expansion. FIGS. 19 and 20 schematically illustrate the shape of the deformable film 127 upon expansion, and FIG. 21 schematically illustrates a positional relationship between the deformable film 127 and the circulation hole 131. In FIGS. 19 to 21, the circulation holes 131 are referred to as a circulation hole 131a, a circulation hole 131b, and a circulation hole 131c in order of closeness to the center of the circulation hole plate 123. When the internal pressure in the third space 113 reaches a specified pressure, the deformable film 127 expands into a hemispherical shape, and the top of the deformable film 127 is brought into contact with the circulation hole plate 123, as illustrated in FIG. 19.

In FIG. 21, a range H1 indicates a contact range in which the deformable film 127 is in contact with the circulation hole plate 123 at this point. In this case, only the circulation hole 131a situated in the range H1 is closed with the deformable film 127. Further, when the internal pressure in the third space 113 is increased, the deformable film 127 further expands, and a portion of the deformable film 127 that is in contact with the circulation hole plate 123 has a shape extending along the plate surface of the circulation hole plate 123, as illustrated in FIG. 20. In FIG. 21, a range H2 indicates a contact range in which the deformable film 127 is in contact with the circulation hole plate 123 at this point. In this case, the circulation holes 131a to 131c situated in the range H2 are closed with the deformable film 127. As described above, the number of circulation holes 131 closed with the deformable film 127 is changed according to an amount of deformation of the deformable film 127.

A loss caused when air passes through the circulation hole 131 is substantially proportional to the opening area of the circulation hole 131. Thus, the flow path resistance is increased as the circulation hole 131 is gradually closed due to expansion of the deformable film 127. This results in starting to show damper effects of the first deformable body 101. When the deformable film 127 closes all of the circulation holes 131, the first space 111 is hermetically sealed, and a large spring constant is exhibited due to air spring action. As described above, the area of and a position of the circulation hole 131 can be designed in consideration of, for example, a desired damper effect size and the deformation characteristics of the deformable film 127.

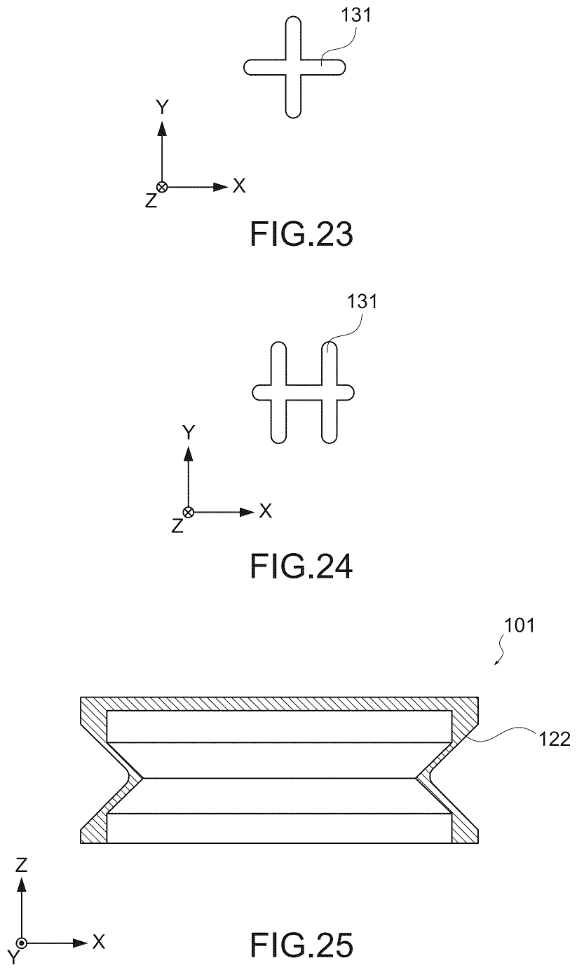

FIG. 21 illustrates the circulation hole 131 having a circular shape. However, the circulation hole 131 is not limited to being circular. FIGS. 22 to 24 illustrate examples of the circulation holes 131 having other shapes. In each of FIGS. 22 to 24, at least one circulation hole 131 is provided to a portion that is included in the circulation hole plate 123 and with which the deformable film 127 is brought into contact, and a portion of the at least one circulation hole 131 that is closed with the deformable film 127 is increased with deformation of the deformable film 127. As described above, the circulation hole 131 may be shaped such that the area of a portion of the circulation hole 131 that is closed with the deformable film 127 is changed according to an amount of deformation of the deformable film 127.

### Regarding Other Configurations

Other configurations of the reaction force controlling apparatus 100 are described. FIG. 25 is a cross-sectional view illustrating another configuration of the first deformable body 101. As illustrated in the figure, one of surfaces of the bellows 122 may be integrally formed without the upper plate 121 being included in the bellows 122.

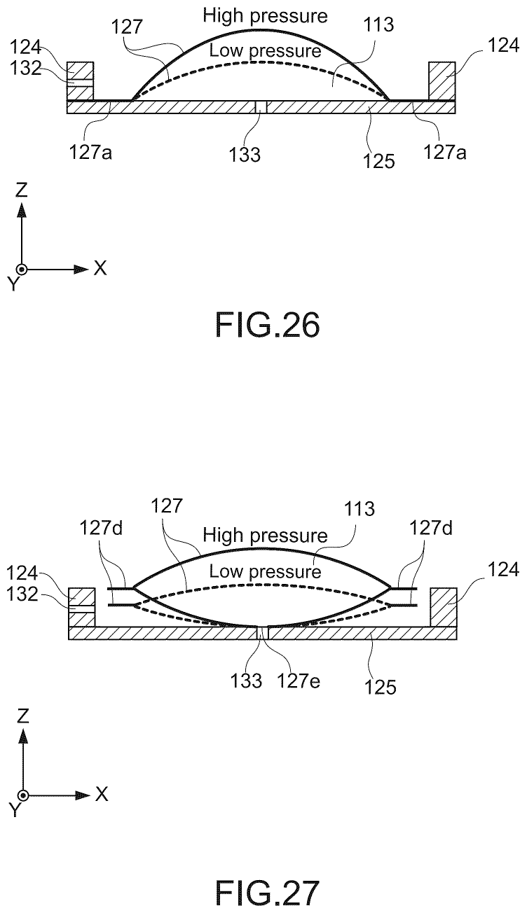

FIGS. 26 to 29 are cross-sectional views illustrating other configurations of the second deformable bodies 104. As illustrated in FIG. 26, the fixation portion 127a of the deformable film 127 may be provided up to a position, on the deformable film 127, that is situated further inward than a range occupied by the spacer 124. Further, as illustrated in FIG. 27, the second deformable body 104 may be formed by joining portions 127d of two deformable films 127 being joined to each other, where the joining portions 127d respectively correspond to the outer peripheral portions of the two deformable films 127. An opening 127e that is connected to the second flow path 133 is provided to the deformable film 127 situated on the side of the air circulation plate 125, and the second flow path 133 communicates with the third space 113 provided between the two deformable films 127. A portion that is included in the deformable film 127 situated on the side of the air circulation plate 125 and that is situated around the opening 127e is joined to the air circulation plate 125.

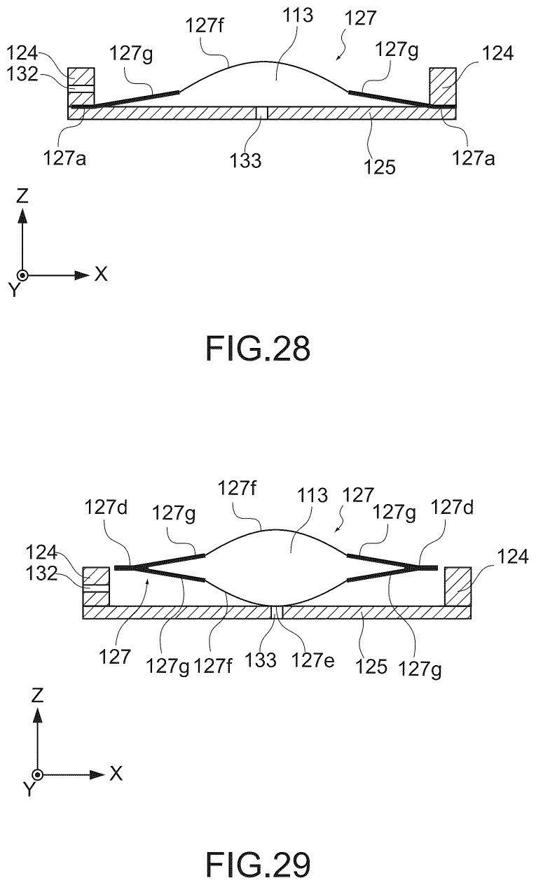

Further, the deformable film 127 may include a thin film portion 127f having a small thickness, and a thick film portion 127g having a large thickness, as illustrated in FIGS. 28 and 29. The thin film portion 127f is situated on an inner peripheral side of the deformable film 127, and the thick film portion 127g is situated on an outer peripheral side of the deformable film 127. When the deformable film 127 expands, an amount of deformation of the thick film portion 127g is small, and an amount of deformation of the thin film portion 127f is large. Thus, a degree of curvature of a portion of the deformable film 127 that is brought into contact with the circulation hole 131 can be decreased relative to the internal pressure in the third space 113. This makes it possible to reduce a volume in the third space 113 upon expansion, and to secure a pushing force applied by the deformable film 127 to the circulation hole plate 123 due to the internal pressure in the third space 113.

### Regarding Examples

A reaction force controlling apparatus according to examples of the present technology is described.

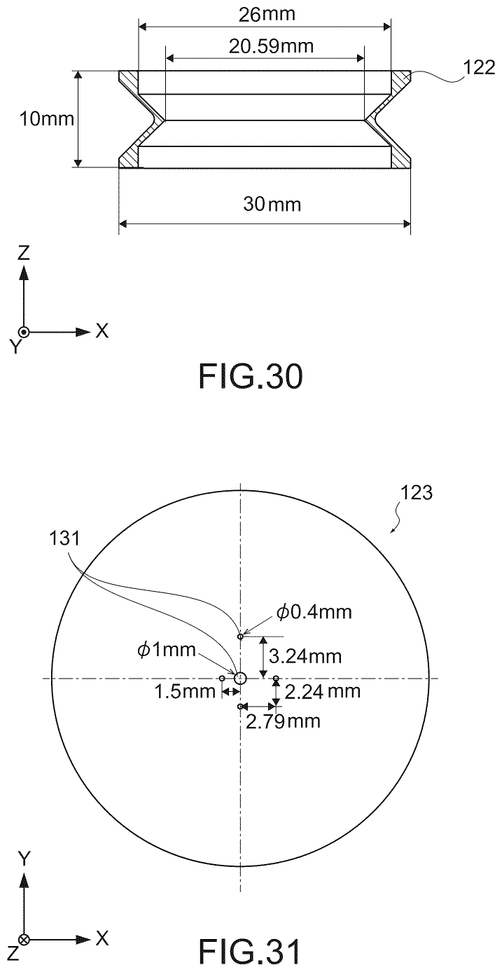

It is assumed that the reaction force controlling apparatus according to the examples of the present technology has a configuration of the reaction force controlling apparatus 100 illustrated in FIG. 9, and has the following size. FIG. 30 schematically illustrates an example of a size of the bellows 122. As illustrated in the figure, the bellows 122 has an outer diameter of 30 mm, an inner diameter of 20.59 mm, and a height of 10 mm, where the bending portion of the bellows 122 includes one pleated portion, has a thickness of 0.5 mm, and exhibits a degree of hardness of 30.

FIG. 31 schematically illustrates an example of a size of the circulation hole plate 123 and an example of arrangement of the circulation holes 131. As illustrated in the figure, the circulation hole plate 123 has a diameter of 30 mm and a thickness of 0.2 mm, where the circulation hole 131 having a diameter of 1 mm is provided to a center portion of the circulation hole plate 123, and the circulation hole 131 having a diameter of 0.4 mm is provided to a portion of the circulation hole plate 123 that is distant from the center portion.

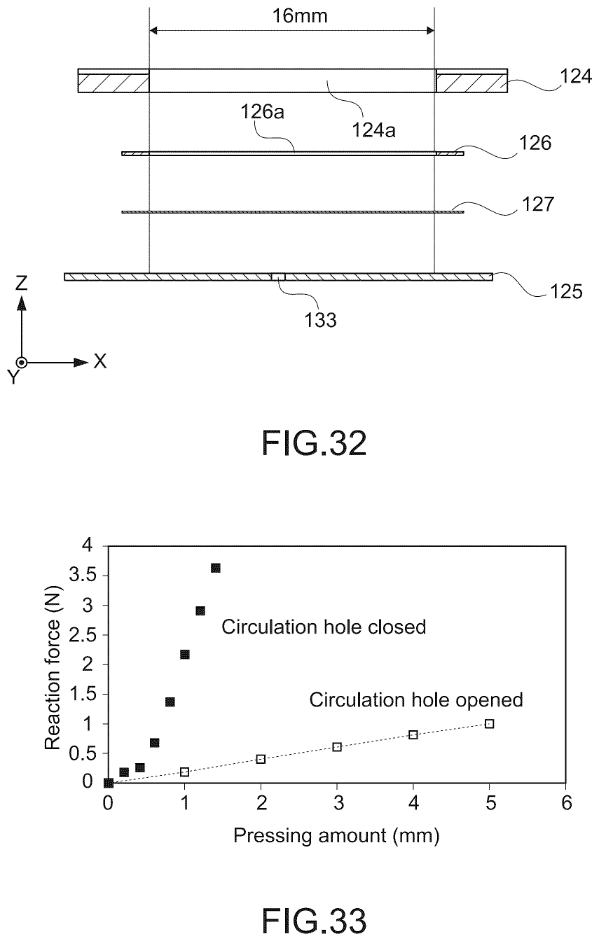

FIG. 32 schematically illustrates sizes of the spacer 124, the air circulation plate 125, the holding plate 126, and the deformable film 127. As illustrated in the figure, the spacer 124 includes the opening 124a having a diameter of 16 mm. The air circulation plate 125 has an outer diameter of 30 mm, and a thickness of 0.2 mm. The holding plate 126 includes the opening 126a having a diameter of 16 mm, and has a thickness of 0.2 mm. The deformable film 127 is made of silicon rubber, where the deformable film 127 exhibits a degree of hardness of 40, and has a diameter of 30 mm and a thickness of 0.5 mm. The outer peripheral region of the deformable film 127 is fixed with the holding plate 126. Thus, a region that can be deformed has a diameter of 18 mm. A distance between the deformable film 127 and the circulation hole plate 123 is 2 mm in consideration of an amount of deformation of the deformable film 127.

FIG. 33 illustrates a result of measuring an amount of pressing of the bellows 122 and a static reaction force of the bellows 122 in the reaction force controlling apparatus 100 according to the examples. A pressing speed at which the bellows 122 is pressed was sufficiently low, and the measurement result did not include damper effects. In the figure, “Circulation hole opened” shows a result of the measurement performed when none of the circulation holes 131 are closed with the deformable film 127, with the internal pressure in the third space 113 being 0 kPa. “Circulation hole closed” shows a result of the measurement performed when all of the circulation holes 131 are closed with the deformable film 127, with the internal pressure in the third space 113 being 15 kPa.

In the case of “Circulation hole opened”, the reaction force is increased as the pressing amount is increased. The reason is that there is an increase in resistance to deformation of the bellows 122. In the case of “Circulation hole closed”, the reaction force is rapidly increased relative to the pressing amount, compared with the case of “Circulation hole opened”. The reason is that the reaction force due to air is increased since the first space 111 is hermetically sealed. When the internal pressure in the third space 113 is made higher, this results in further improving capabilities in sealing the first space 111.

As described above, the reaction force controlling apparatus 100 exhibits a large difference in spring constant (reaction force/pressing amount) between “Circulation hole opened” and “Circulation hole closed”. An appropriate change in supply pressure applied to the third space 113 makes it possible to provide a user with a very soft spring-like feeling or a very stiff spring-like feeling when the user pushes the bellows 122.

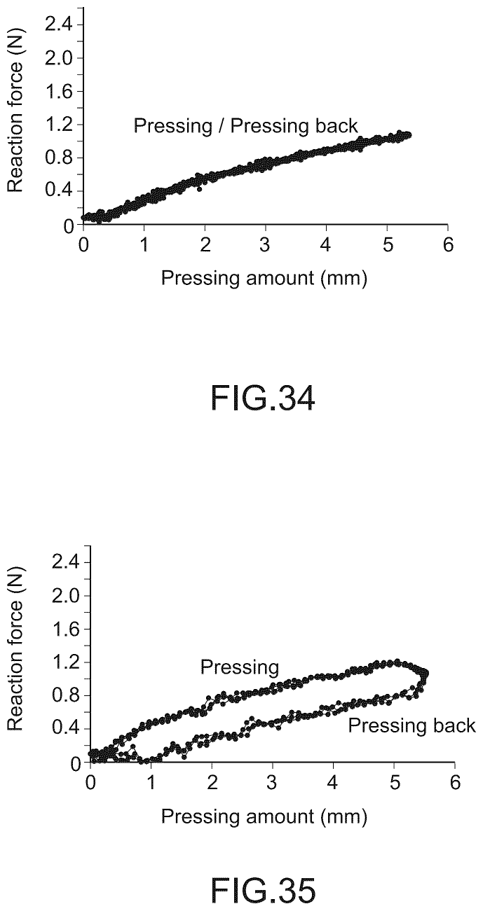

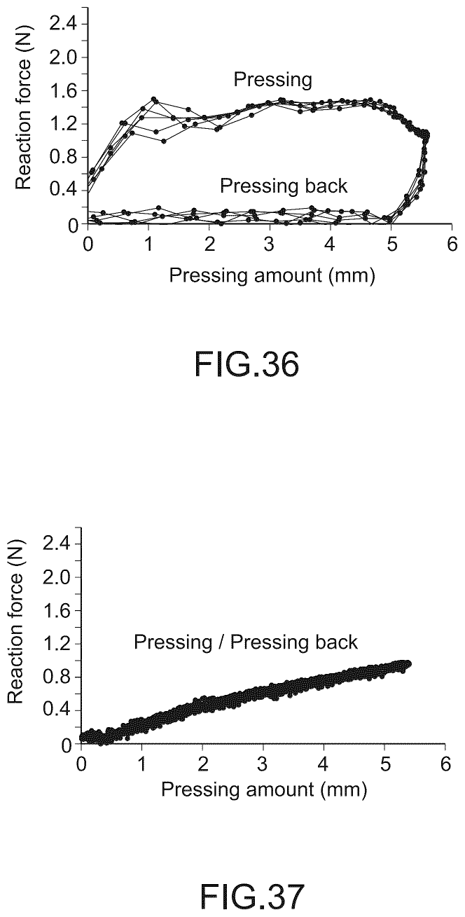

FIGS. 34 to 39 illustrate results of measuring an amount of pressing the bellows 122 and a reaction force of the bellows 122 in the reaction force controlling apparatus 100 according to the examples. In each of FIGS. 34 to 36, the internal pressure in the third space 113 was 2 kPa. FIG. 34 illustrates a result of the measurement performed when the pressing speed at which the bellows 122 is pressed was 1 mm/s, FIG. 35 illustrates a result of the measurement performed when the pressing speed was 10 mm/s, and FIG. 36 illustrates a result of the measurement performed when the pressing speed was 50 mm/s. A portion of the circulation holes 131 was closed with the deformable film 127 when the internal pressure in the third space 113 was 2 kPa.

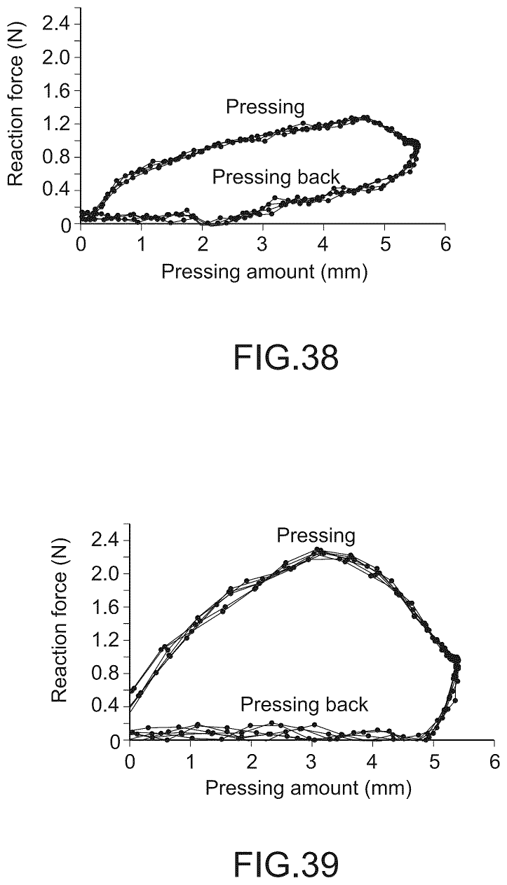

In each of FIGS. 37 to 39, the internal pressure in the third space 113 was 10 kPa. FIG. 37 illustrates a result of the measurement performed when the pressing speed at which the bellows 122 is pressed was 1 mm/s, FIG. 38 illustrates a result of the measurement performed when the pressing speed was 10 mm/s, and FIG. 39 illustrates a result of the measurement performed when the pressing speed was 50 mm/s. All of the circulation holes 131 were closed with the deformable film 127 when the internal pressure in the third space 113 was 10 kPa. Note that, in FIGS. 34 to 39, “Pressing” refers to a reaction force caused when the bellows 122 is pressed, and “Pressing back” refers to a reaction force caused when the pressed bellows 122 returns to its original state.

When comparison is performed between FIGS. 34 to 36, the curve of the reaction force differs depending on the pressing speed, which shows that a damper effect was shown. In FIGS. 35 and 36, “Pressing” and “Pressing back” exhibit different reaction forces. The reason is that air in the first space 111 is discharged to the outside through the second space 112 due to pressing being performed at a high speed, and air is delayed in being intaken into the first space 111 when the bellows 122 returns to its original state. Particularly in FIG. 36 in which the pressing speed is high, the reaction force upon “Pressing back” is very small. Likewise, in FIGS. 37 to 39, the curve of the reaction force differs depending on the pressing speed, which shows that a damper effect was shown.

Further, when comparison is performed between FIGS. 35 and 38, the curve of the reaction force differs depending on the internal pressure in the third space 113, which shows that a damper effect was changed according to a change in the opening area of the circulation hole 131. Likewise, when comparison is performed between FIGS. 36 and 39, the curve of the reaction force differs depending on the internal pressure in the third space 113, which shows that a damper effect was changed according to a change in the opening area of the circulation hole 131.

As described above, the configuration of the reaction force controlling apparatus 100 makes it possible to control a spring effect and a damper effect that are provided due to pushing being performed. Thus, for example, curves of reaction forces caused on various objects such as a cushion, a human body, and a mixture are measured, and supply pressure applied to the third space 113 is changed to provide conformity to profiles of the curves of the reaction forces. This makes it possible to provide a user with a feeling close to a stiff or soft feeling or repulsion feeling that is provided by an object.

### Regarding Reaction Force Controlling System

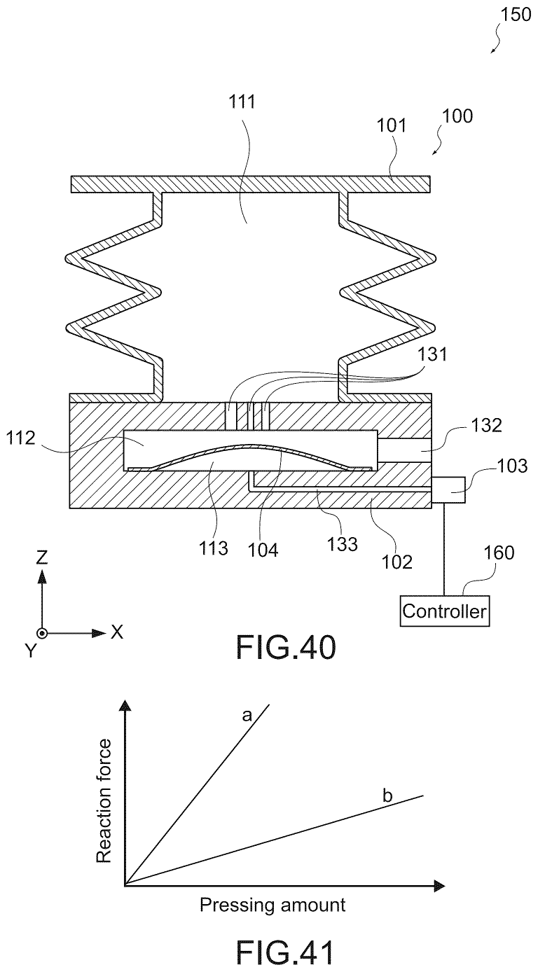

A reaction force controlling system according to the present embodiment is described. FIG. 40 schematically illustrates a reaction force controlling system 150 according to the present embodiment. As illustrated in the figure, the reaction force controlling system 150 includes the reaction force controlling apparatus 100 and a controller 160. The reaction force controlling apparatus 100 has the configuration described above. The controller 160 has a functional configuration implemented by hardware and software working cooperatively, and controls the first fluid control mechanism 103 to adjust the internal pressure in the third space 113.

The controller 160 keeps a relationship between an amount of deformation of the second deformable body 104 and the internal pressure in the third space 113, and can adjust the internal pressure in the third space 113 such that an amount of deformation of the second deformable body 104 is a specified amount. Specifically, the controller 160 can increase or decrease, by controlling the internal pressure in the third space 113, the opening area of a portion of the circulation hole 131 that is closed with the second deformable body 104. Accordingly, the controller 160 can adjust the internal pressure in the third space 113 on the basis of designation performed by, for example, a user or an application, and control a spring effect and a damper effect that are provided to the reaction force controlling apparatus 100.

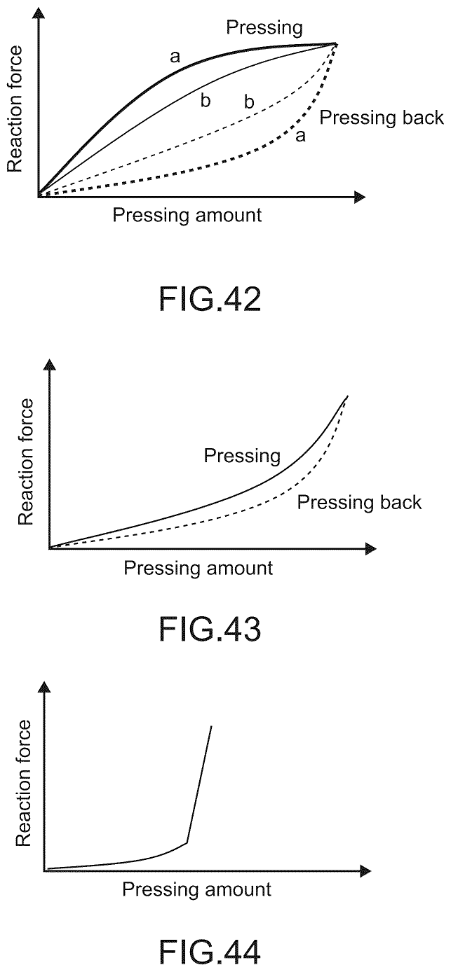

FIGS. 41 to 44 are graphs in which examples of controlling a reaction force caused on the first deformable body 101 are given, the control being performed by the controller 160. As illustrated in FIG. 41, the controller 160 enables reaction-force characteristics to be linear characteristics, and can also switch between characteristics (a) and characteristics (b) (the same applies to the figures described below). Further, as illustrated in FIGS. 42 and 43, the controller 160 also enables the reaction-force characteristics to be non-linear characteristics. Note that, in FIGS. 42 and 43, the reaction force upon performing pressing is indicated by a solid line, and the reaction force upon performing pressing back is indicated by a dashed line. Furthermore, the controller 160 also enables the reaction-force characteristics to be discontinuous characteristics, as illustrated in FIG. 44.

### Regarding Use of Sensor Output

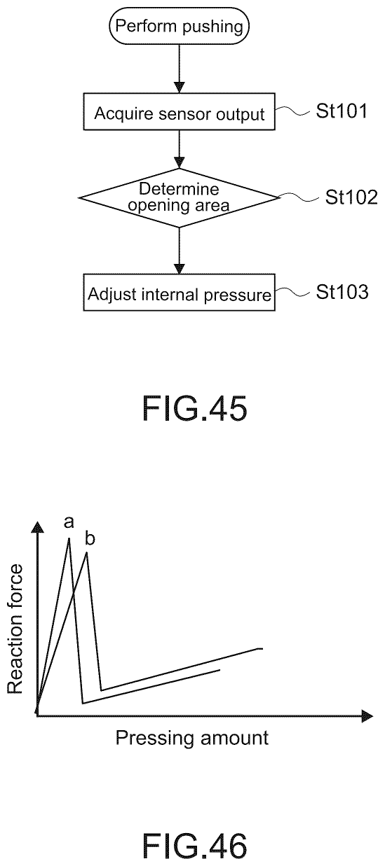

The reaction force controlling system 150 includes a sensor, and the controller 160 can also control the first fluid control mechanism 103 on the basis of output from a sensor. Specifically, the reaction force controlling system 150 may include at least one of a load sensor that detects a load applied to the first deformable body 101, or a range sensor that detects an amount of deformation of the first deformable body 101. FIG. 45 is a flowchart illustrating an operation of the controller 160 that is based on output from a sensor. As illustrated in the figure, the controller 160 acquires output from a sensor when the first deformable body 101 is pushed (St101).

The controller 160 determines the opening area of the circulation hole 131 on the basis of the output from the sensor (St102). The controller 160 can determine the opening area dependent on the output from the sensor by referring to a preset reaction-force-characteristics library. The controller 160 controls the first fluid control mechanism 103 to adjust the internal pressure in the third space 113 such that the circulation hole 131 has the determined opening area (St103). When the output from the sensor reaches a threshold, the controller 160 may change a third internal pressure, and may change the third internal pressure as necessary according to the output from the sensor. Accordingly, the reaction force controlling system 150 can change the internal pressure in the third space 113 according to a load applied to the first deformable body 101 or an amount of pressing the first deformable body 101, and can change a spring effect and a damper effect that are provided due to a reaction force.

FIGS. 46 to 49 are graphs in which examples of controlling a reaction force caused on the first deformable body 101 are given, the control being performed by the controller 160 on the basis of output from a sensor. The controller 160 can provide reaction-force characteristics of rapidly reducing a reaction force when a pressing amount is a specified amount and increasing thereafter the reaction force, as illustrated in FIG. 46. Specifically, when a sensor detects the first pressing performed with respect to the first deformable body 101, the controller 160 increases the internal pressure in the third space 113. This results in the circulation hole 131 being closed with the second deformable body 104. Accordingly, a great reaction force is caused. When an amount of pressing the first deformable body 101 reaches a threshold, the controller 160 reduces the internal pressure in the third space 113. Accordingly, the circulation hole 131 is not closed with the second deformable body 104, and a reaction force caused by the first deformable body 101 being pressed is greatly reduced when an amount of the pressing exceeds a threshold.

Here, a user is provided with a stiff feeling first. When pressing is performed to some extent, a reaction force is suddenly reduced. This causes the user to feel as if a reaction force is rapidly reduced, such as a feeling of cutting an object using scissors with no resistance from the moment the cut starts to be made, or a feeling of firing a gun. As described above, the controller 160 can change the reaction-force characteristics of the first deformable body 101 by controlling the first fluid control mechanism 103 on the basis of output from a sensor. Further, the controller 160 makes it possible to perform more complicated representations of a reaction force by performing finer pressure control with respect to a pressing amount. This also makes it possible to change the reaction force in the process of pressing in order of a “weak reaction force”, a “strong reaction force”, and a “weak reaction force”.

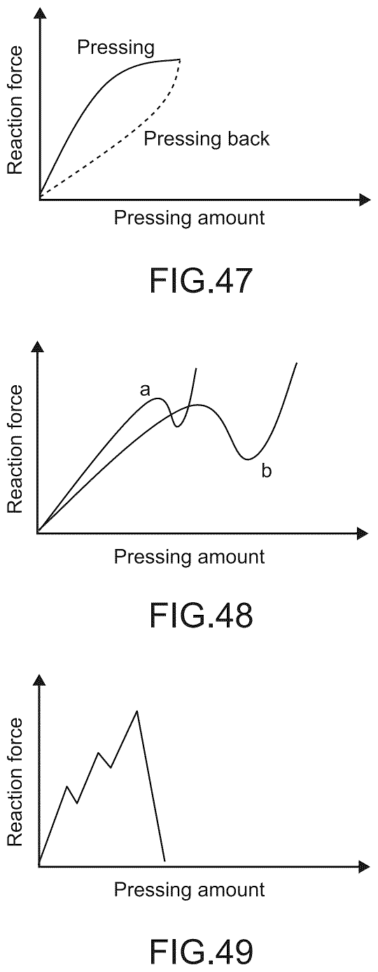

Further, the controller 160 can provide reaction-force characteristics such as a feeling provided by a damper-feel providing pedal, as illustrated in FIG. 47, and can provide reaction-force characteristics such as a clicking feel, as illustrated in FIG. 48. Furthermore, the controller 160 can provide reaction-force characteristics such as a crumbling feel or a crack feel by reducing a reaction force for each specified pressing amount, as illustrated in FIG. 49. As described above, the controller 160 changes the internal pressure in the third space 113 on the basis of output from a load sensor or a range sensor. Accordingly, the controller 160 can provide various kinds of reaction-force characteristics.

### Regarding Application Examples

The configurations of the reaction force controlling apparatus 100 and the reaction force controlling system 150 make it possible to cause a user to feel various kinds of reaction forces when the user performs an operation of pressing the first deformable body 101. Further, the provision of a load sensor or a range sensor to the reaction force controlling system 150 makes it possible to detect a pushing force of the first deformable body 101 or an amount of pressing the first deformable body 101, and to perform control to change a dumping component or a spring constant component according to the pushing force or the pressing amount.

This enables the reaction force controlling apparatus 100 and the reaction force controlling system 150 to be applied to a switch for which a reaction force is changed according to a pressing amount, a feeling of a reaction force caused when an object is cut or crushed, a feeling of a reaction force caused when an object is broken, and a feeling of hardness of a composite of soft and stiff materials, such as a human body (a flexible structure including therein bones).

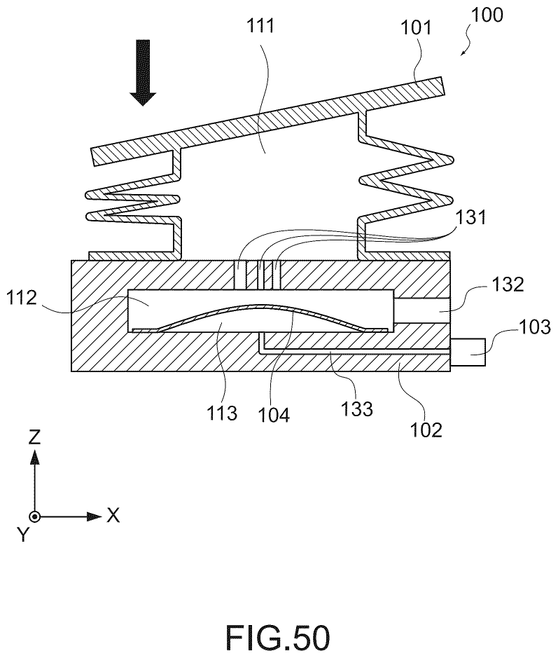

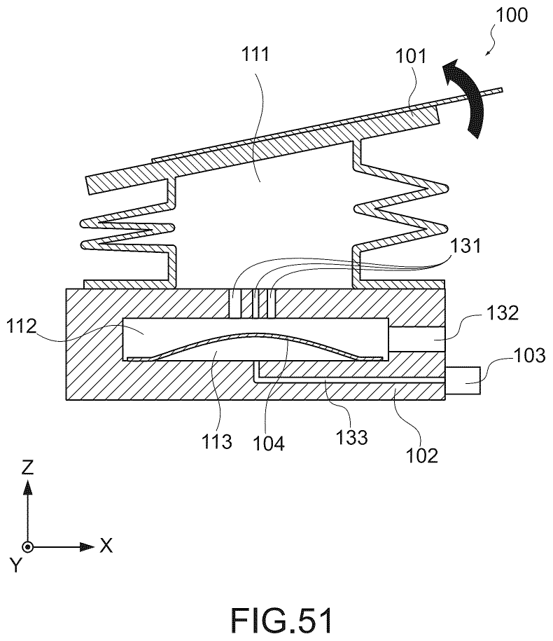

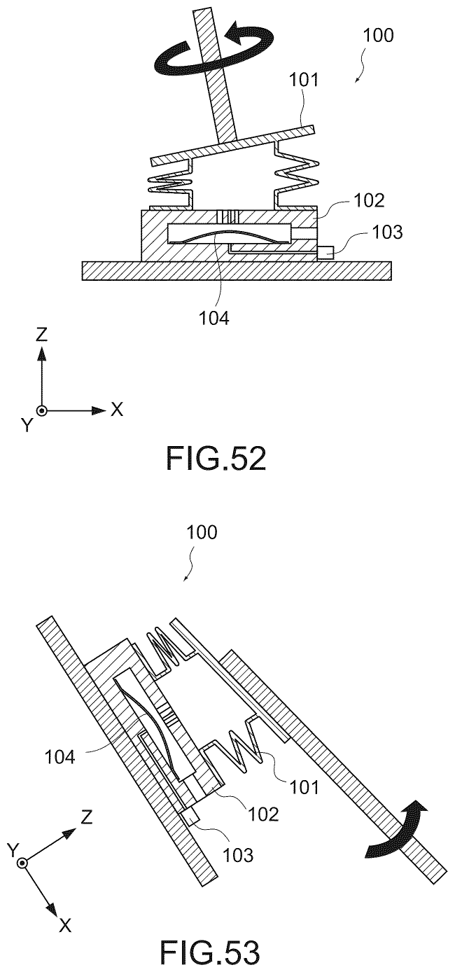

Further, the reaction force controlling apparatus 100 and the reaction force controlling system 150 can also be applied to not only the provision of a reaction force caused when a user performs pushing, but also other uses. For example, the reaction force controlling apparatus 100 and the reaction force controlling system 150 can be applied to an actuator mechanism of, for example, a robot. FIGS. 50 and 51 schematically illustrate deformation of the bellows 122. As illustrated in FIGS. 50 and 51, the bellows 122 is flexible in deformation performed in a direction other than the vertical direction, and can provide an oscillating mechanism as illustrated in FIG. 52 and a joint mechanism as illustrated in FIG. 53. The use of the reaction force controlling apparatus 100 in an actuator mechanism makes it possible to change, for example, the hardness (the resistance) with respect to a stretching motion or the hardness (the resistance) with respect to a bending motion. The reaction force controlling apparatus 100 can also be used as an active shock absorber that can change a damper effect.

Further, the reaction force controlling apparatus 100 and the reaction force controlling system 150 can also be applied to an actuator of a vibration isolation base. The adjustment of the opening area of the circulation hole 131 also makes it possible to cancel vibration generated due to a specified vibration frequency.

### Regarding Modifications

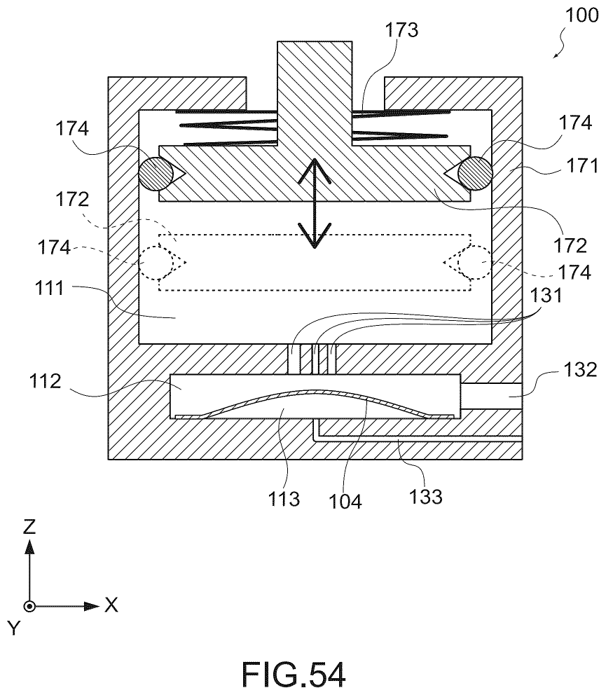

Modifications of the reaction force controlling apparatus 100 are described. FIGS. 54 to 56 are cross-sectional views of the reaction force controlling apparatus 100 according to the modifications.

As illustrated in FIG. 54, the first deformable body 101 may have a piston structure, and may include a cylinder 171, a piston 172, a spring 173, and an O-ring 174. The piston 172 is connected to the cylinder 171 by use of the spring 173, and can move up and down within the cylinder 171. The O-ring 174 is arranged between the piston 172 and the cylinder 171 to seal a space situated between the piston 172 and the cylinder 171. In this configuration, the space between the piston 172 and the cylinder 171 is the first space 111. In this configuration, the second deformable body 104 also changes the opening area of the circulation hole 131 to control flow of air into the second space 112 from the first space 111. This makes it possible to change a spring effect and a damper effect that are provided due to the piston 172 being pressed.

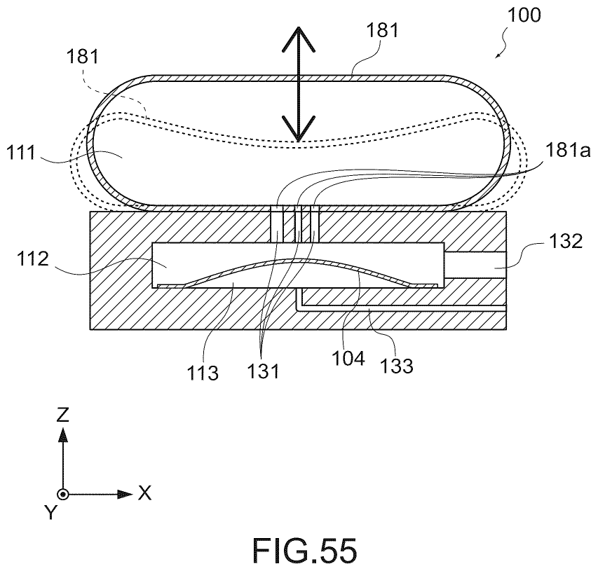

Further, as illustrated in FIG. 55, the first deformable body 101 may have a balloon structure, and may be a balloon 181. The balloon 181 is in the form of a sack and is formed using a film made of an elastic material. The balloon 181 is connected to the base 102. An internal space of the balloon 181 is the first space 111. An opening 181a that communicates with the circulation hole 131 is provided to the balloon 181, and the first space 111 communicates with the second space 112 through the opening 181a and the circulation hole 131. In this configuration, the second deformable body 104 also changes the opening area of the circulation hole 131 to control flow of air into the second space 112 from the first space 111. This makes it possible to change a spring effect and a damper effect that are provided due to the balloon 181 being pressed.

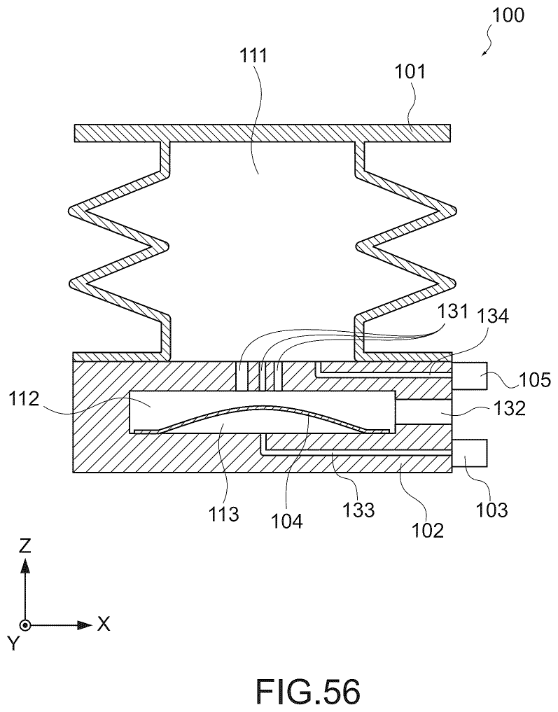

Further, the reaction force controlling apparatus 100 may include a third flow path 134 and a second fluid control mechanism 105, as illustrated in FIG. 56. The third flow path 134 is provided between the first space 1112 and an external space. The second fluid control mechanism 105 causes air to flow into the first space 111 through the third flow path 134, and causes air to flow out of the first space 111. The second fluid control mechanism 105 is, for example, a pump.

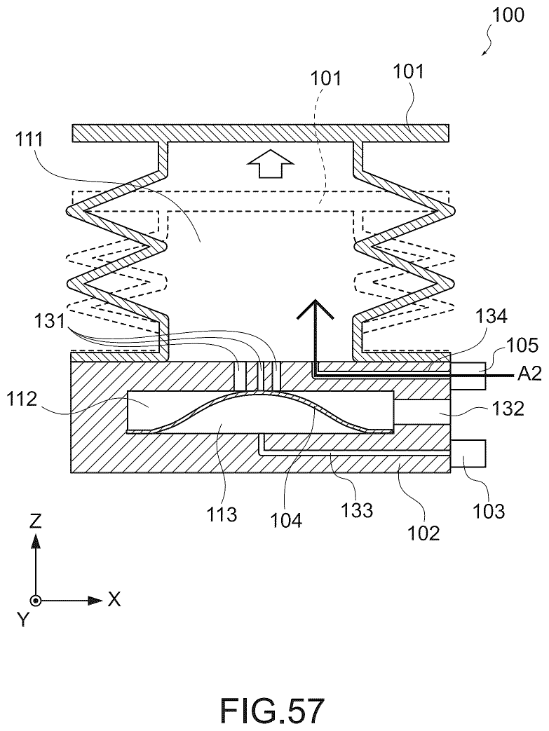

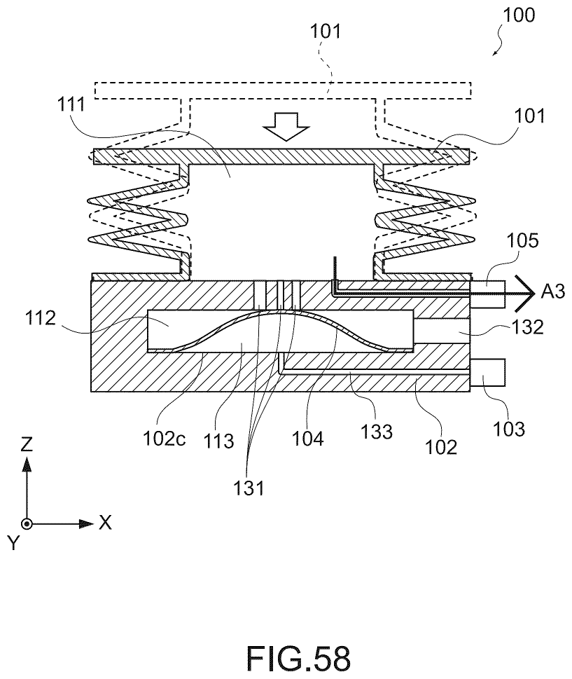

FIGS. 57 and 58 schematically illustrate the operation of the reaction force controlling apparatus 100. In the case of this structure, the second fluid control mechanism 105 causes air to flow into the first space 111 through the third flow path 134 in a state in which the circulation hole 131 is closed with the second deformable body 104, as indicated by an arrow A2 in FIG. 57. This enables the first deformable body 101 to expand. Further, the second fluid control mechanism 105 causes air to flow into the first space 111 through the third flow path 134 in a state in which the circulation hole 131 is closed with the second deformable body 104, as indicated by an arrow A3 in FIG. 58. This enables the first deformable body 101 to shrink. Furthermore, the first fluid control mechanism 103 changes an amount of deformation of the second deformable body 104. This also makes it possible to adjust the internal pressure in the first space 111. The reaction force controlling apparatus 100 can also form the reaction force controlling system 150 by the controller 160 being connected to the reaction force controlling apparatus 100. In this case, the controller 160 can control the first fluid control mechanism 103 and the second fluid control mechanism 105 to simultaneously adjust the internal pressure in the first space 111 and the internal pressure in the third space 113.

### Hardware Configuration of Controller

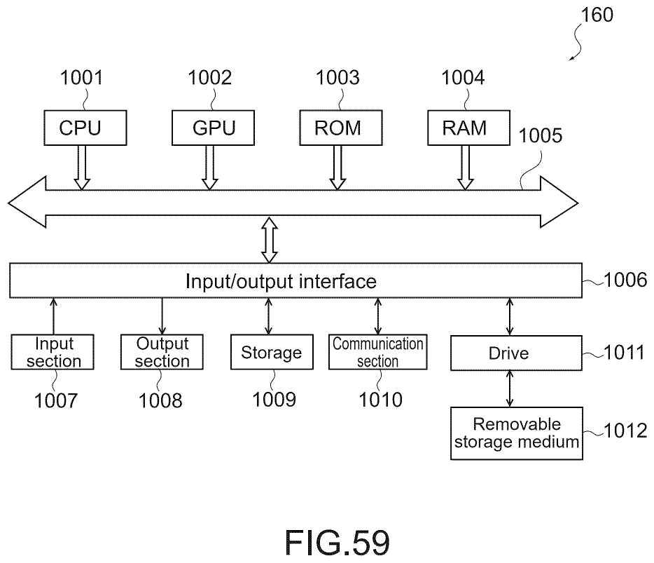

A hardware configuration that makes it possible to implement a functional configuration of the controller 160 is described. FIG. 59 schematically illustrates the hardware configuration.

As illustrated in the figure, the controller 160 includes a central processing unit (CPU) 1001 and a graphics processing unit (GPU) 1002. An input/output interface 1006 is connected to the CPU 1001 and the GPU 1002 via a bus 1005. A read only memory (ROM) 1003 and a random access memory (RAM) 1004 are connected to the bus 1005.

An input section 1007, an output section 1008, a storage 1009, and a communication section 1010 are connected to the input/output interface 1006. The input section 1007 includes input devices such as a keyboard and a mouse that are used by a user to input an operation command. The output section 1008 outputs a processing operation screen and an image of a processing result to a display device. The storage 1009 includes, for example, a hard disk drive that stores therein a program and various data. The communication section 1010 includes, for example, a local area network (LAN) adapter, and performs communication processing through a network as represented by the Internet. Further, a drive 1011 is connected to the input/output interface 1006. The drive 1011 reads data from and writes data into a removable storage medium 1012 such as a magnetic disk, an optical disk, a magneto-optical disk, or a semiconductor memory.

The CPU 1001 performs various processes in accordance with a program stored in the ROM 1003, or in accordance with a program that is read from the removable storage medium 1012 such as a magnetic disk, an optical disk, a magneto-optical disk, or a semiconductor memory to be installed on the storage 1009, and is loaded into the RAM 1004 from the storage 1009. Data necessary for the CPU 1001 to perform various processes is also stored in the RAM 1004 as necessary. The GPU 1002 performs calculation processing necessary to draw an image under the control of the CPU 1001.

In the controller 160 having the configuration described above, the series of processes described above is performed by the CPU 1001 loading, for example, a program stored in the storage 1009 into the RAM 1004 and executing the program via the input/output interface 1006 and the bus 1005.

For example, the program executed by the controller 160 can be provided by being recorded in the removable storage medium 1012 serving as, for example, a package medium. Further, the program can be provided via a wired or wireless transmission medium such as a local area network, the Internet, or digital satellite broadcasting.

In the controller 160, the program can be installed on the storage 1009 via the input/output interface 1006 by the removable storage medium 1012 being mounted on the drive 1011. Further, the program can be received by the communication section 1010 via the wired or wireless transmission medium to be installed on the storage 1009. Moreover, the program can be installed in advance on the ROM 1003 or the storage 1009.

Note that the program executed by the controller 160 may be a program in which processes are chronologically performed in the order of the description in the present disclosure, or may be a program in which processes are performed in parallel or a process is performed at a necessary timing such as a timing of calling. Further, all of the hardware configuration of the controller 160 does not have to be included in a single apparatus, and the controller 160 may include a plurality of apparatuses. Further, a portion of or all of the hardware configuration of the controller 160 may be included in a plurality of apparatuses connected to each other via a network.

### Regarding Present Disclosure

The effects described in the present disclosure are not limitative but are merely illustrative, and other effects may be provided. The above-described description of the plurality of effects does not necessarily mean that the plurality of effects is provided at the same time. The above-described description means that at least one of the effects described above is provided depending on, for example, a condition. There is a possibility that an effect that is not described in the present disclosure will be provided. Further, at least two of the features described in the present disclosure can also be used in combination.

Note that the present technology may also take the following configurations.

(1) A reaction force controlling apparatus, including:
a first deformable body that includes a first space inside of the first deformable body, the first space having a variable volume;
a base that includes
   a second space that communicates with the first space through a circulation hole, and
   a third space that does not communicate with the first space or the second space; and
a second deformable body that separates the second space from the third space, the second deformable body being deformed to change the opening area of the circulation hole, the deformation being performed due to fluid flowing into the third space or flowing out of the third space.

(2) The reaction force controlling apparatus according to (1), in which
the second deformable body
   expands due to the flow of the fluid into the third space to close a portion of or all of the circulation hole, and
   shrinks due to the flow of the fluid out of the third space to be spaced from the circulation hole.

(3) The reaction force controlling apparatus according to (1) or (2), further including
a first fluid control mechanism that causes the fluid to flow into the third space, and that causes the fluid to flow out of the third space.

(4) The reaction force controlling apparatus according to (3), in which
the second space communicates with an external space through a first flow path, and
the third space is connected to the first fluid control mechanism through a second flow path.

(5) The reaction force controlling apparatus according to (4), further including
a second fluid control mechanism that causes the fluid to flow into the first space, and that causes the fluid to flow out of the first space, in which
the first space is connected to the second fluid control mechanism through a third flow path.

(6) The reaction force controlling apparatus according to any one of (1) to (5), in which
a plurality of the circulation holes is provided, and
the number of the circulation holes closed with the second deformable body is changed according to an amount of the deformation of the second deformable body.

(7) The reaction force controlling apparatus according to any one of (1) to (5), in which
the circulation hole is shaped such that the area of a portion of the circulation hole that is closed with the second deformable body is changed according to an amount of the deformation of the second deformable body.

(8) The reaction force controlling apparatus according to any one of (1) to (7), in which
the first deformable body has a bellows structure.

(9) The reaction force controlling apparatus according to any one of (1) to (7), in which
the first deformable body has a piston structure.

(10) The reaction force controlling apparatus according to any one of (1) to (7), in which
the first deformable body has a balloon structure.

(11) The reaction force controlling apparatus according to any one of (1) to (10), in which
the second deformable body is a stretchable deformable film.

(12) A reaction force controlling system, including:
a reaction force controlling apparatus that includes
   a first deformable body that includes a first space inside of the first deformable body, the first space having a variable volume,
   a base that includes
      a second space that communicates with the first space through a circulation hole, and
      a third space that does not communicate with the first space or the second space,
   a second deformable body that separates the second space from the third space, the second deformable body being deformed to change the opening area of the circulation hole, the deformation being performed due to fluid flowing into the third space or flowing out of the third space, and
   a first fluid control mechanism that causes the fluid to flow into the third space, and that causes the fluid to flow out of the third space; and
a controller that controls the first fluid control mechanism to adjust an internal pressure in the third space.

(13) The reaction force controlling system according to (12), in which
the controller
   keeps a relationship between an amount of the deformation of the second deformable body and the internal pressure in the third space, and
   adjusts the internal pressure in the third space such that the amount of the deformation of the second deformable body is a specified amount.

(14) The reaction force controlling system according to (12), further including
a load sensor that detects a load applied to the first deformable body, in which
the controller adjusts the internal pressure in the third space on the basis of output from the load sensor.

(15) The reaction force controlling system according to (14), in which
the controller changes the internal pressure in the third space as necessary according to the load.

(16) The reaction force controlling system according to (12), further including
a range sensor that detects an amount of deformation of the first deformable body, in which
the controller adjusts the internal pressure in the third space on the basis of output from the range sensor.

(17) The reaction force controlling system according to (16), in which
the controller changes the internal pressure in the third space as necessary according to the amount of the deformation.

(18) The reaction force controlling system according to any one of (12) to (17), in which
the controller adjusts the internal pressure in the third space on the basis of input performed by a user.

(19) The reaction force controlling system according to any one of (12) to (17), in which
the controller adjusts the internal pressure in the third space on the basis of designation performed by an application.

(20) The reaction force controlling system according to any one of (12) to (19), in which
the reaction force controlling apparatus further includes a second fluid control mechanism that causes the fluid to flow into the first space, and that causes the fluid to flow out of the first space,
the first space is connected to the second fluid control mechanism through a third flow path, and
the controller further controls the second fluid control mechanism to adjust an internal pressure in the first space.

### REFERENCE SIGNS LIST

100 reaction force controlling apparatus
101 first deformable body
102 base
103 first fluid control mechanism
104 second deformable body
105 second fluid control mechanism
111 first space
112 second space
113 third space
131 circulation hole
132 first flow path
133 second flow path
134 third flow path
150 reaction force controlling system
160 controller

1. A reaction force controlling apparatus, comprising:
a first deformable body that includes a first space inside of the first deformable body, the first space having a variable volume;
a base that includes
a second space that communicates with the first space through a circulation hole, and
a third space that does not communicate with the first space or the second space; and
a second deformable body that separates the second space from the third space, the second deformable body being deformed to change the opening area of the circulation hole, the deformation being performed due to fluid flowing into the third space or flowing out of the third space.

2. The reaction force controlling apparatus according to claim 1, wherein
the second deformable body
expands due to the flow of the fluid into the third space to close a portion of or all of the circulation hole, and
shrinks due to the flow of the fluid out of the third space to be spaced from the circulation hole.

3. The reaction force controlling apparatus according to claim 1, further comprising
a first fluid control mechanism that causes the fluid to flow into the third space, and that causes the fluid to flow out of the third space.

4. The reaction force controlling apparatus according to claim 3, wherein
the second space communicates with an external space through a first flow path, and
the third space is connected to the first fluid control mechanism through a second flow path.

5. The reaction force controlling apparatus according to claim 4, further comprising
a second fluid control mechanism that causes the fluid to flow into the first space, and that causes the fluid to flow out of the first space, wherein
the first space is connected to the second fluid control mechanism through a third flow path.

6. The reaction force controlling apparatus according to claim 1, wherein
a plurality of the circulation holes is provided, and
the number of the circulation holes closed with the second deformable body is changed according to an amount of the deformation of the second deformable body.

7. The reaction force controlling apparatus according to claim 1, wherein
the circulation hole is shaped such that the area of a portion of the circulation hole that is closed with the second deformable body is changed according to an amount of the deformation of the second deformable body.

8. The reaction force controlling apparatus according to claim 1, wherein
the first deformable body has a bellows structure.

9. The reaction force controlling apparatus according to claim 1, wherein
the first deformable body has a piston structure.

10. The reaction force controlling apparatus according to claim 1, wherein
the first deformable body has a balloon structure.

11. The reaction force controlling apparatus according to claim 1, wherein
the second deformable body is a stretchable deformable film.

12. A reaction force controlling system, comprising:
a reaction force controlling apparatus that includes
a first deformable body that includes a first space inside of the first deformable body, the first space having a variable volume,
a base that includes
a second space that communicates with the first space through a circulation hole, and
a third space that does not communicate with the first space or the second space,
a second deformable body that separates the second space from the third space, the second deformable body being deformed to change the opening area of the circulation hole, the deformation being performed due to fluid flowing into the third space or flowing out of the third space, and
a first fluid control mechanism that causes the fluid to flow into the third space, and that causes the fluid to flow out of the third space; and
a controller that controls the first fluid control mechanism to adjust an internal pressure in the third space.

13. The reaction force controlling system according to claim 12, wherein
the controller
keeps a relationship between an amount of the deformation of the second deformable body and the internal pressure in the third space, and
adjusts the internal pressure in the third space such that the amount of the deformation of the second deformable body is a specified amount.

14. The reaction force controlling system according to claim 12, further comprising
a load sensor that detects a load applied to the first deformable body, wherein
the controller adjusts the internal pressure in the third space on a basis of output from the load sensor.

15. The reaction force controlling system according to claim 14, wherein
the controller changes the internal pressure in the third space as necessary according to the load.

16. The reaction force controlling system according to claim 12, further comprising
a range sensor that detects an amount of deformation of the first deformable body, wherein
the controller adjusts the internal pressure in the third space on a basis of output from the range sensor.

17. The reaction force controlling system according to claim 16, wherein
the controller changes the internal pressure in the third space as necessary according to the amount of the deformation.

18. The reaction force controlling system according to claim 12, wherein
the controller adjusts the internal pressure in the third space on a basis of input performed by a user.

19. The reaction force controlling system according to claim 12, wherein
the controller adjusts the internal pressure in the third space on a basis of designation performed by an application.

20. The reaction force controlling system according to claim 12, wherein
the reaction force controlling apparatus further includes a second fluid control mechanism that causes the fluid to flow into the first space, and that causes the fluid to flow out of the first space,
the first space is connected to the second fluid control mechanism through a third flow path, and
the controller further controls the second fluid control mechanism to adjust an internal pressure in the first space.
